(19) United States
(12) Patent Application Publication
(10) Pub. No.: US 2023/0128816 A1
(43) Pub. Date: Apr. 27, 2023

(54) ENERGY STORAGE DEVICE, ENERGY STORAGE SYSTEM WITH THE SAME AND CONTROL METHOD, PRE-CHARGING CIRCUIT FOR AN ENERGY STORAGE DEVICE

(71) Applicant: Torqeedo GmbH, Wessling (DE)

(72) Inventor: Jens Biebach, Gilching (DE)

(73) Assignee: Torqeedo GmbH, Wessling (DE)

(21) Appl. No.: 17/966,102

(22) Filed: Oct. 14, 2022

(30) Foreign Application Priority Data
Oct. 15, 2021 (DE) 102021126882.6

(51) Int. Cl. H02J 7/00; H01M 50/204; H01M 50/296; H01M 10/44; H01M 10/42; H01M 50/512; B60L 58/18

(52) U.S. Cl. CPC H02J 7/007; H02J 7/0013; H01M 50/204; H01M 50/296; H01M 10/441; H01M 10/425; H01M 50/512; B60L 58/18; H01M 2220/20; B60L 58/12

(57) ABSTRACT

The present disclosure relates to an energy storage device for a water vessel, the energy storage device comprising: a first connection and a second connection, an energy storage unit with a first pole and a second pole, a first connection line between the first pole and the first connection and a second connection line between the second pole and the second connection, wherein the first connection line has a first node, which is connected with the first pole, and a second node, which is connected with the first connection, and wherein the second connection line has a fourth node, which is connected with the second pole and the second connection, a third connection line between the first node and the second node, with a third node and an inductance between the third node and the second node, and a fourth connection line between the third node and the fourth node with a free-wheeling diode, which is arranged for a current from the fourth node to the third node in forward direction, a first switching unit in the first connection line between the first node and the second node for switching a current from the first node to the second node and a third switching unit in the third connection line between the first node and the third node for switching a current from a first node to the third node, and a control unit, which is configured for controlling the first switching unit and/or the third switching unit for limiting the strength of a discharge current for the energy storage unit to a predefined discharge threshold value. The disclosure further relates to an energy storage system with at least two such energy storage devices and control method for the energy storage device and for the energy storage system and a pre-charging circuit.

### RELATED APPLICATION(S)

This application claims priority to and the benefit of German Patent Application No. DE 10 2021 126 882.6, FILED Oct. 16, 2021, the contents of which is incorporated herein by reference in its entirety.

### FIELD

The present disclosure relates to an energy storage device, in particular an electric energy storage device, for a water vessel and an energy storage system for a water vessel with at least two such energy storage devices, which are connected in a parallel circuit with each other. The disclosure further relates to control methods for the energy storage device and for the energy storage system and a pre-charging circuit for an energy storage device.

### BACKGROUND

Electric energy storage devices, for example batteries, are used for the electric supply of a load, amongst other things. The load can for example be an electric drive motor of a water vehicle, such as a boat, a ship or a ferry. Batteries, in particular lithium ion-based batteries, normally have an integrated main switch for safety reasons, which can interrupt at least the current flowing out of the battery, in particular a discharge current. Batteries can further also be connected initially connected with each other or for switching on a battery bank including several batteries in order to form a switched-on battery bank.

If a battery is connected with a load that has a voltage source feature, for example a capacitor, a high compensating current flows from battery and load when closing the main switch in the case of different voltage heights, which can damage the main switch and further circuit components of the battery. It is therefore desirable to adjust or adapt the voltage heights of battery and load prior to closing the main switch to each other. A pre-charging circuit is normally used for this.

Simple pre-charging circuits comprise or consist of just one switched resistor. Here, the pre-charging current varies very strongly as a function of the voltage at the battery connections or the load voltage. Depending on the load capacity, very large power loss pulses may occur in the resistor, which is why the dimensioning of the resistor for various capacity values is problematic. If the load has not only capacitive, but also ohmic components it is often not possible, due to the voltage division between the resistance of the pre-charging circuit and of the load during pre-charging, to achieve a voltage height at the load with which a closing of the main switch is possible without problems.

If two identical batteries with different charge states (“state of charge”, abbreviated to “SOC”), and thus different voltage heights are connected in parallel with each other to form a battery bank, a compensation of the energy content between the batteries will take place as a compensating current flows from the battery with the higher voltage to the battery with the lower voltage. According to Kirchhoff's law current flowing from the battery with the higher voltage or the higher charge state must be equal to the current that flows into the battery with the lower voltage or the lower charge state. If several identical batteries are switched together to form a battery bank a pre-charging circuit must therefore be capable of compensating different charge states of the batteries in the shortest possible time with minimum loss. Compensating the energy content of batteries in a sufficiently short time requires a compensating current of a suitable, and therefore adequate height. At the same time, a circuit with a current limiting resistor has a poor degree of effectiveness.

External charging devices, also called chargers, for such batteries typically have a so-called CCCV (“Constant Current, Constant Voltage”) charging characteristic or carry out a CCCV charging method. During a constant current phase, charging takes place at a constant charging current, which is limited by the external charging device. This is followed by a constant voltage phase, during which charging takes place at a constant voltage, which is provided by the external charging device. The transition from the constant current phase to the constant voltage phase takes place when the battery voltage reaches a predefined charging end voltage. The battery voltage is monitored by the external charging device. The charging current drops slowly during the constant voltage phase and charging ends when the charging current falls below a threshold value. The external charging device is typically equipped with negative tolerance to ensure that no critical overcharging, and thus damage to the battery, occurs. This means that the external charging device changes to the constant voltage phase as soon as the battery voltage reaches a value that lies below the actual charging end voltage of the battery. This tolerance varies between charging devices. This leads to the batteries not normally reaching an SOC (“abbreviation of “State Of Charge”, in German “Ladezustand”) of 100%. This will in turn make a recalibration of the SOC measurement more difficult. In complex installations with long cables and staged safety devices it is also possible that the constant voltage phase is substantially extended due to the larger cable resistance and that no satisfactory SOC can be realized within an acceptable charging time.

### SUMMARY

In some aspects, the techniques described herein relate to an energy storage device for a water vessel, the energy storage device including a first connection and a second connection, an energy storage unit with a first pole and a second pole, a first connection line between the first pole and the first connection and a second connection line between the second pole and the second connection, wherein the first connection line has a first node, which is connected with the first pole, and a second node, which is connected with the first connection, and wherein the second connection line has a fourth node, which is connected with the second pole and the second connection, a third connection line between the first node and the second node, with a third node and an inductance between the third node and the second node, a fourth connection line between the third node and the fourth node, and a free-wheeling diode, which is arranged in the fourth connection line, which is arranged for a current from the fourth node to the third node in forward direction, a first switching unit in the first connection line between the first node and the second node for switching a current from the first node to the second node and a third switching unit in the third connection line between the first node and the third node for switching a current from a first node to the third node, and a control unit, which is configured for controlling the first switching unit and/or the third switching unit for limiting the strength of a discharge current for the energy storage unit to a predefined discharge current threshold value.

In some aspects, the first switching unit includes a first switch and a first diode connected with the first switch in parallel, which is arranged for a current from the first node to the second node in reverse direction and/or wherein the third switching unit includes a third switch and a third diode connected with the third switch in parallel, which is arranged for a current from the first node to the third node in reverse direction.

In some aspects, the first switching unit and/or the third switching unit are formed as power switches, in particular as power transistors, preferably as MOSFETs, wherein the corresponding diode is preferably formed by the parasitic diode of the same.

In some aspects, the control unit is configured for switching the first switching unit and/or the third switching unit based on a pulse width modulation method, a two-point regulation method, a hysteresis regulation method and/or a linear regulation method and/or wherein the control unit is formed as a limiting regulator, preferably as a linear limiting regulator, or includes the same.

In some aspects, the control unit is configured for switching the first switching unit and/or the third switching unit based on or depending on at least one of the following: a direction and/or strength of a current across the first connection line between the first connection and the second node, a direction and/or strength of a current across the third connection line between the third node and the second node, a direction and/or strength of a current across the first connection line between the first node and the first pole, a strength of a charging current for the energy storage unit, a strength of the discharge current for the energy storage unit, a height of the voltage of the energy storage unit, a height of the voltage at the connections, a relationship between these voltage heights.

In some aspects, the control unit is configured for closing the first switching unit when a current flows from the first connection to the second node or when a charging current flows, and for opening the third switching unit after closing the first switching unit, and/or wherein the control unit is configured for opening the third switching unit when the current strength of a discharge current and/or a current from the third node to the second node is equal to or greater than a predefined first threshold value or exceeds the first threshold value, and for closing the third switching unit when the current strength is equal to or smaller than a predefined second threshold value or falls short of the same, wherein the second threshold value is equal to or smaller than the first threshold value, and/or wherein the control unit is configured for alternately opening and closing the switching unit in such a way that a median time value or a maximum value of the current strength of the discharge current and/or the current from the third node to the second node is equal to or smaller than the discharge current threshold value.

In some aspects, the control unit is configured for closing the first switching unit and for opening the third switching unit after closing the first switching unit when the current strength of a current from the third node to the second node and/or the discharge current for the energy storage unit is equal to or smaller than the predefined third threshold value or falls short of the same and/or when a difference between a voltage at the connections and a voltage at the energy storage unit is equal to or smaller than a predefined fourth threshold value or falls short of the same.

In some aspects, the energy storage device further includes a second switching unit, wherein the second switching unit is arranged in the first connection line between the first node and the first pole and is configured for switching a current from the first node to the first pole, or wherein the second switching unit is arranged in the second connection line between the second pole and the fourth node and is configured for switching a current from the second pole to the fourth node.

In some aspects, the second switching unit includes a second switch and a second diode connected with the second switch in parallel, which is arranged for a current from the first node to the first pole in reverse direction, or wherein the second switching unit includes a second switch and a second diode connected with the second switch in parallel, which is arranged for a current from the second pole to the fourth node in reverse direction.

In some aspects, the energy storage device further includes a fourth switching unit, which includes the free-wheeling diode, wherein the fourth switching unit is arranged in the fourth connection line between the third node and the fourth node and is configured for switching a current from the third node to the fourth node.

In some aspects, the fourth switching unit is formed as a power switch, in particular as a power transistor, preferably as a MOSFET, wherein the free-wheeling diode is preferably formed by a parasitic diode of the same.

In some aspects, the control unit is configured for alternately closing and opening the fourth switching unit in such a way that a median time value or a minimum value of the current strength of the charging current and/or the current across the first connection line between the first connection and the second node is equal to or greater than a predefined booster threshold value.

In some aspects, the energy storage unit is or includes at least one battery cell and/or wherein the energy storage unit is or includes at least one battery module with at least one battery cell.

In some aspects, the at least one battery cell is a lithium based battery cell, in particular a lithium ion based battery cell.

In some aspects, the techniques described herein relate to energy storage system for a water vessel, including two or more energy storage devices 13 to 14, which are connected with each other in parallel by means of a first and second connections.

In some aspects, the techniques described herein relate to a pre-charging control method for an energy storage device 1 to 14, including the steps: closing the first switching unit when a current flows from the first connection to the second node or when a charging current flows, after closing the first switching unit, opening the third switching unit and/or opening the third switching unit when a current strength of a current from the third node to the second node or a discharge current is greater than a predefined first threshold value or exceeds the first threshold value, and closing the third switching unit when the current strength is equal to or smaller than a predefined second threshold value or falls short of the second threshold value, wherein the second threshold value is equal to or smaller than the first threshold value and/or alternating opening of the third switching unit and closing of the third switching unit based on a predefined pre-charging switching frequency and/or based on a predefined pre-charging duty cycle, wherein the pre-charging switching frequency and/or the pre-charging duty cycle are changed continuously and/or in stages, and/or closing the first switching unit when the current strength of the current from the third node to the second node and/or the current strength of the discharge current is equal to or smaller than a predefined third threshold value or falls short of the third threshold value and/or when a difference between the height of the voltage at the energy storage unit and the height of the voltage at the connections is equal to or smaller than a predefined fourth threshold value or falls short of the fourth threshold value.

In some aspects, the techniques described herein relate to a charging control method for an energy storage device 8 to 14, including the steps: alternating closing of the fourth switching unit and opening of the fourth switching unit, wherein the fourth switching unit is alternately opened and closed based on a predefined charging switching frequency and/or based on a predefined charging duty cycle.

In some aspects, the techniques described herein relate to a pre-charging control method for the energy storage system, including the steps: closing the second switching unit 16 for all of the energy storage devices of the energy storage system.

In some aspects, the techniques described herein relate to a charging control method for the energy storage system, including the steps: carrying out the charging control method for at least one of the energy storage devices of the energy storage system.

In some aspects, the techniques described herein relate to an energy storage device for a water vessel, the energy storage device including: a first connection and a second connection, and an energy storage unit that is connected with the first connection and the second connection, wherein the energy storage device is configured for being connected in parallel with at least one further energy storage device by means of the first connection and the second connection, a control unit and a pre-charging circuit, wherein the control unit is configured for controlling the pre-charging circuit for limiting the strength of a discharge current for the energy storage unit to a predefined discharge current threshold value.

In some aspects, the techniques described herein relate to a pre-charging circuit for an energy storage device for a water vessel, the energy storage device including: a first connection and a second connection, an energy storage unit with a first pole and a second pole, a first connection line between the first pole and the first connection and a second connection line between the second pole and the second connection, wherein the first connection line has a first node, which is connected with the first pole, and a second node, which is connected with the first connection, and wherein the second connection line has a fourth node, which is connected with the second pole and the second connection, a first switching unit in the first connection line between the first node and the second node for switching a current from the first node to the second node, the pre-charging circuit including: a third connection line with a first end, which can be connected with the first node, and a second end, which can be connected with the second node, a third node between the first end and the second end and an inductance between the third node and the second end,—a fourth connection line with a first end, which is connected with the third node, and a second end, which can be connected with a fourth node, a free-wheeling diode in the fourth connection line between the first end and the second end of the fourth connection line, which is arranged for a current from the third node to the second end of the fourth connection line in reverse direction, and a third switching unit in the third connection line between the first end of the third connection line and the third node for switching a current from the first end of the third connection line to the third node.

In some aspects, the techniques described herein relate to a pre-charging circuit, further including a fourth switching unit, which includes the free-wheeling diode, wherein the fourth switching unit is arranged in the fourth connection line between the first end and the second end of the fourth connection line and is configured for switching a current from the third node to the second end of the fourth connection line.

### BRIEF DESCRIPTION OF THE FIGURES

Exemplary embodiments of the disclosure will be described in more detail in the following description of the figures:

FIG. 1 shows a schematic view of an energy storage device for a water vessel according to the embodiments of the present disclosure;

FIG. 2 shows a schematic view of an energy storage device for a water vessel according to the embodiments of the present disclosure;

FIG. 3 shows a schematic view of an energy storage device for a water vessel according to the first embodiment of the present disclosure;

FIG. 4 shows a schematic view of an energy storage device for a water vessel according to the embodiments of the present disclosure;

FIG. 5 shows a schematic view of an energy storage device for a water vessel according to the second embodiment of the present disclosure;

FIG. 6 shows a schematic view of an energy storage device for a water vessel according to the embodiments of the present disclosure;

FIG. 7 shows a pre-charging control method according to the embodiments of the present disclosure;

FIG. 8 shows a pre-charging control method according to a first embodiment of the present disclosure;

FIG. 9 shows a pre-charging control method according to a second embodiment of the present disclosure; and

FIG. 10 shows a charging control method according to an embodiment of the present disclosure.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

Based on known prior art, in some aspects, the present disclosure provides an energy storage device that removes the said problems of prior art. It is one aspect of the present disclosure to provide an energy storage device that can be realized simply, safely and cost effectively.

In some aspects, the present disclosure provides an energy storage device with which compensating currents in an energy storage system can be limited in a simple, safe and cost-effective way when switching several energy storage devices in parallel, and a safe pre-charging of the energy storage devices, but also of loads and consumers, is possible.

In some aspects, the present disclosure provides an energy storage device with an improved charging option. It is another aspect of the present disclosure to provide an energy storage device that can be charged safety as well as quickly. It is in particular an aspect of the present disclosure to provide an energy storage device with which a charging of the same up to an SOC of substantially 100% is possible in a fast, safe and cost-effective way.

In some embodiments, the present disclosure provides an energy storage system with such an energy storage device as well as control methods for controlling such an energy storage device and such an energy storage system.

The present disclosure provides a pre-charging circuit for an energy storage device, for example a battery, with an energy storage unit, for example at least one battery module. The energy storage device can therefore be configured for limiting the current strength of a discharge current for the energy storage unit to a predefined discharge current threshold value by means of a pre-charging circuit. The pre-charging circuit can therefore have the character of a (constant) current source in this regard. A compensating current between energy storage devices connected with each other in parallel which is mostly independent of the charge states of the batteries is therefore possible. The pre-charging circuit is preferably formed as a regulated, cycled (constant) current source, which can minimize ohmic loss.

On the other hand, the energy storage device can be configured not to limit the current strength of the charging current, i.e., a current with the opposite direction of the discharge current, for the energy storage unit or the energy storage device has a significantly higher charging current threshold value, also called current limit, for the current strength of the charging current, than for the discharge current. The pre-charging circuit therefore has the character of a (constant) voltage source in this regard.

In an energy storage system, for example in a battery system or in a battery bank, with at least two energy storage devices connected with each other in parallel, the energy storage unit with the higher charge state, and thus with the higher voltage in the discharge current, can be limited when compensating energy contents, while the energy storage unit with the lower charge state, and thus with the lower voltage in the charging current, is not limited. The pre-charging circuit can also be described as a compensating circuit. The pre-charging (control) methods disclosed here can consequently be described as compensating (control) methods.

The fact that a purpose of the energy storage unit can include supplying an electric load that has no energy storage unit of its own connected with the same is also accounted for with the pre-charging circuit according to the disclosure. The pre-charging circuit according to the disclosure is further configured for changing the character of a current source to a voltage source or vice versa depending on the direction of the current flowing from or to the energy storage unit and/or on the relationship of the voltage at the energy storage unit to the voltage at the outer connections of the energy storage device.

As the energy storage units of the energy storage devices to be switched together can have a higher (or excessively high) voltage compared to the other energy storage units as well as a lower (or excessively low) voltage compared to the other energy storage units, the pre-charging circuit can have the respective correct character for each situation. If the respective energy storage unit for example has a higher voltage than the other energy storage units in the energy storage system, the current source character can become effective, and if the energy storage unit has a lower voltage the voltage source character or the character of the current source can become effective with a clearly higher current limit.

According to a first aspect of the present disclosure an energy storage device for a water vessel is provided, said energy storage device comprising: a first connection, also described as a terminal, and a second connection, and an energy storage unit with a first pole and a second pole, wherein the first pole is connected with the first connection and the second pole with the second connection.

The energy storage device further comprises a pre-charging circuit and a control unit. The control unit is configured for controlling the pre-charging circuit in order to limit the strength of a discharge current for the energy storage unit to a predefined discharge current threshold value. Limiting to the discharge current threshold value here means that the strength of the discharge current is or remains equal to or smaller than the discharge current threshold value or does not exceed the discharge current threshold value. The control unit can in particular be configured for controlling the pre-charging circuit in such a way that a maximum value of the current strength of the discharge current or a median time value of the current strength can be equal to or smaller than the predefined discharge current threshold value or does not exceed the discharge value threshold value.

The energy storage device can further be configured for not limiting the strength of a charging current for the energy storage unit or for limiting the strength of the charging current threshold value that is greater than the discharge current threshold value.

According to a second aspect of the present disclosure an energy storage device for a water vessel is provided, said energy storage device comprising: a first connection and a second connection, an energy storage unit with a first pole and a second pole, a first connection line between the first pole and the first connection and a second connection line between the second pole and the second connection.

The first pole is therefore connected by means of the first connection line with the first connection, and the second pole is connected by means of the second connection line with the second connection. The first connection line has a first node, which is connected with the first pole, and a second node, which is connected with the first connection. The second connection line has a fourth node, which is connected with the second pole and the second connection.

The energy storage device further comprises a first switching unit, which is arranged in the first connection line between the first node and the second node, and which is configured for switching a current from the first node to the second node. The first switching unit can also be described as a first main switch.

The energy storage device further comprises a pre-charging circuit. The pre-charging circuit comprises a third connection line between the first node and the second node, with a third node and an inductance between the third node and the second node, a fourth connection line between the third node and the fourth node, and a free-wheeling diode, which is arranged in the fourth connection line and is arranged for a current from the fourth node to the third node in forward direction. The third connection line accordingly comprises a first end, which is connected or can be connected with the first node, and a second end, which is connected or can be connected with the second node. The third node is therefore arranged between the first end and the second end of the third connection line and the inductance between the third node and the second end of the third connection line. The fourth connection line therefore comprises a first end, which is connected with the third node, and a second end, which is connected or can be connected with the fourth node. The free-wheeling diode is therefore arranged in the fourth connection line between the first end and the second end of the fourth connection line, and is arranged for a current from the third node or from the first end to the second end of the fourth connection line in reverse direction. The pre-charging circuit comprises a third switching unit, which is arranged in the third connection line between the first node or the first end of the third connection line and the third node, and is configured for switching a current from the first node or from the first end of the third connection line to the third node.

The energy storage device further comprises a control unit for controlling the pre-charging circuit. As part of the present disclosure “controlling” comprises controlling (open loop) as well as regulating (closed loop). The control unit can be configured for controlling the pre-charging circuit, for limiting the strength of a discharge current for the energy storage unit to the predefined discharge current threshold value. The control unit can in particular be configured for switching the first switching unit and/or the third switching unit, in order to limit the strength of the discharge current for the energy storage unit to the predefined discharge current threshold value.

This pre-charging circuit also advantageously enables a current limitation for discharge currents of the energy storage unit, i.e. currents that flow from the energy storage unit. On the other hand no current limitation or a substantially higher current limitation takes place for charging currents, namely currents that flow into the energy storage unit. The pre-charging circuit comprises no ohmic resistor. The pre-charging circuit is therefore low-loss. By means of the pre-charging circuit, the load can be removed from the main switch by parallel connection of several energy storage devices, in particular with the same nominal voltage of the energy storage unit and during connection with a consumer or load, in particular with a capacitive and/or ohmic load.

According to a further aspect of the present disclosure an energy storage system for a water vessel is provided, wherein the energy storage system comprises N energy storage devices according to embodiments of the present disclosure, wherein the N energy storage devices are connected with each other by means of the first and second connections in parallel connection. Here, N is a natural number equal or greater than 2.

As part of this disclosure an “(electric) connection” between two elements, for example components, poles, connections or nodes, or an equivalent formulation, describes that a connection exists between the same that is electrically conductive or carries a current, i.e. an electric current can flow between the same. The electric connection can be formed by a connection line, line for short, between the same, wherein the connection line can have at least one electric or electronic component. “Directly connected” in this context means that a connection line between the elements has no further electric or electronic components.

A switching of an electric connection or a current comprises the establishing of an electric connection, so that a current flow across the same is possible and the disconnection/interruption of the electric connection, so that the current flow is interrupted or no current flow is possible or a current flow is prevented. The disconnection of the electric connection can for example be realized through interrupting or disconnecting the connection line, for example by means of a switch or a transistor, so that the two ends of the connection line are electrically isolated from each other. The establishing of the current-carrying connection can be realized through closing the connection line, so that a current can (again) flow between the two ends.

A current or current flow between two elements or nodes comprises a current in one direction between the two elements and a current in the other, opposite direction. A current or current flow from a first element to a second element describes a current with positive current strength from the first element to the second element. A value of the current or a current strength means the absolute of the current strength. The discharge current describes a current from or out of the energy storage unit via the first pole for discharging the energy storage unit, and the charging current describes a current across the first pole to or into the energy storage unit for charging the energy storage unit. A charging of the energy storage device means a charging of the energy storage unit with this, and a discharging of the energy storage device means a discharging of the energy storage unit with this.

A connection line can be realized with an electrically conductive medium, for example a strip conductor, a cable or a wire. The switching of a switching unit, a switch or a transistor comprises the opening of these elements, so that the corresponding electric connection or the connection line is disconnected and the closing of these elements, so that the electric connection is established or the connection line closed. The opening can also be described as the switching on or activating and the closing can also be described as the switching off or deactivating.

The terms “battery” or “battery bank” or similar terms are adapted to normal language use for “accumulator” or “accumulator system” or “accumulator bank” in the present disclosure. The same applies for corresponding terms.

A voltage difference between the voltages of the first pole in relation to the voltage of the second pole of the energy storage unit can be described as voltage of the energy storage unit or as voltage at the energy storage unit. A voltage difference of the voltage at the first connection in relation to a voltage at the second connection can be described as voltage of the connections or as voltage at the connections. A parallel connection of the energy storage devices in an energy storage system means that the energy storage devices are connected in parallel by means of the first and second connections. This means the first and second connections of the respective energy storage devices are connected in parallel.

Aspects of the present disclosure can comprise one or more of the following optional features.

The energy storage device can be configured to be connected in parallel with at least one further energy storage device by means of the first connection and the second connection.

The energy storage unit can be configured for storing electric energy. The energy storage unit can be any means for storing energy, which can be charged with electric energy and from which electric energy can be taken. The energy storage unit can be or comprise at least one battery cell. Alternatively or additionally the energy storage unit can be or comprise at least one battery model with at least one battery cell. The at least one battery cell can preferably be a lithium-based battery cell, in particular a lithium ion based battery cell. The energy storage unit can also be or comprise a fly-wheel system or a capacity, for example an electrolyte capacity or a super capacity.

According to the embodiments, the energy storage device comprises a second switching unit. The control unit can be configured for switching the second switching unit. The second switching unit can also be described as a second main switch.

The second switching unit can be arranged in the first connection line between the first node and the first pole and be configured for switching a current from the first node to the first pole. Alternatively or additionally, the second switching unit can be arranged in the second connection line between the second pole and the fourth node and be configured for switching a current from the second pole to the fourth node.

According to the embodiments, the first switching unit can comprise a first switch between the first node and the second node and a first diode in parallel connection with the first switch, which is arranged for a current across the first diode from the first node to the second node in reverse direction. The first diode can be arranged for a current from the second node to the first node in forward direction. The first switch and the first diode are therefore each connected with the first node and the second node. The first diode can therefore be arranged between the first node and the second node.

The third switching unit can also comprise a third switch between the first node and the third node and a third diode connected in parallel with the third switch, which is arranged for a current across the third diode from the first node to the third node in reverse direction. The third diode can be arranged for a current from the third node to the first node in forward direction. The third switch and the third diode are therefore each connected with the first node and the third node. The third diode can therefore be arranged between the first node and the third node.

The second switching unit can also comprise a second switch between the first node and the first pole and a second diode connected in parallel with the second switch, which is arranged for a current across the second diode from the first node to the first pole in reverse direction. The second diode can be arranged for a current from the first pole to the first node in forward direction. The second switch and the second diode are therefore each connected with the first node and the first pole. The second diode can therefore be arranged between the first node and the first pole.

According to exemplary embodiments the energy storage device comprises a fourth switching unit, which is arranged in the connection line between the third node and the fourth node and is configured for switching a current from the third node to the fourth node. The fourth switching unit is arranged in the fourth connection line between the first end and the second end of the fourth connection line and is configured for switching a current from the third node to the second end of the fourth connection line. The fourth switching unit can comprise the free-wheeling diode. The switching unit preferably comprises a fourth switch between the fourth node and the second node, wherein the free-wheeling diode is in parallel connection with the fourth switch. The fourth switch and the free-wheeling diode are each connected with the third node and the fourth node here. The control unit can be configured for switching the fourth switching unit.

Each one of the switching units is configured for switching current in one direction. Each one of the switching units can be configured for letting a current pass in the other direction or not interrupt the same. The first switching unit is for example configured for switching the current from the first node to the second node. The second switching unit is further for example configured for switching current from the first node to the second pole. The third switching unit is for example further configured for switching current from the first node to the third node. The fourth switching unit is also for example configured for switching current from the third node to the fourth node.

The first switching unit can be formed as a power switch, in particular a power transistor, preferably as a MOSFET. The first diode can preferably be formed by a parasitic diode of the same. The second switching unit can also be formed as a power switch, in particular as a power transistor, preferably as a MOSFET. The second diode can preferably be formed by a parasitic diode of the same. The third switching unit can also be formed as a power switch, in particular a power transistor, preferably as a MOSFET. The third diode can preferably be formed as a parasitic diode of the same. The fourth switching unit can particularly preferably be formed as a power switch, in particular as a power transistor, preferably as a MOSFET. The free-wheeling diode can preferably be formed as a parasitic diode of the same. It is preferred for each of the first to fourth switching units to control the MOSFET channel in parallel during the natural diode conductor phase, i.e. to switch on the MOSFET, in order to realize a loss reduction with the current division realized here. The respective power switch can also be described as a power electronic switching element. The power switch can be lockable for a current in just one direction only. In this way the respective switching unit can be configured for switching current in this direction. The power switch can therefore not be lockable for a current in the direction that opposes this direction. The first direction can be described as the forward direction. The other direction can be described as the reverse direction. The power switch can therefore be lockable in forward direction and not lockable in reverse direction.

By means of the second switching unit a charging current for the energy storage unit can therefore be switched. The charging current can for example be interrupted through opening the second switching unit. Furthermore, by means of the first switching unit and the third switching unit, a discharge current can be switched. The discharge current can for example be interrupted through opening the first and third switching units.

The control unit can be configured for carrying out control methods for the energy storage device and/or the energy storage system according to embodiments of the present disclosure. The control unit can in particular be configured for carrying out regulation methods according to embodiments of the present disclosure.

The control unit can be formed as a two-point regulator, hysteresis regulator and/or as a limiting regulator, preferably as a linear limiting regulator.

The control unit can preferably be configured for controlling or switching the first switching unit and/or the second switching unit and/or the third switching unit and/or the fourth switching unit. Controlling the switching units here means the controlling of the switching units in order to switch the switching units, i.e. to open or switch the same on or to close or switch the same off.

The control unit can be configured for repeatedly switching one of the first switching unit, the second switching unit, the third switching unit and the fourth switching unit. The control unit can also be configured for alternately switching at least one of the switching units, i.e. for alternately opening and closing the same. The control unit can in particular be configured for repeatedly and alternately switching at least one of the switching units, in particular based on a predefined switching frequency and/or based on a predefined duty cycle, also described as cycled or periodic switching.

The control unit can be configured for switching at least one of the switching units based on or using a pulse width modulation method. A reciprocal value of the switching frequency can specify a sum of an opening period of the corresponding switching unit and a closing period of the switching unit here. The opening period of the corresponding switching unit can define a time period between the opening and closing here, namely the time period during which the switching unit is open. The closing period of the switching unit can define a time period between closing and opening, namely the time period during which the switching unit is closed. The duty cycle or duty degree can define a relationship between the closing period and the sum of the opening period and the closing period. A large duty cycle can correspond to a large pulse width of the pulse width modulation method here and vice versa. The pulse width can equal the closing period. The cycle degree can also be described as the “duty cycle”.

Alternatively or additionally, the control unit can be configured for switching at last one of the switching units based on or using a two-point regulation method and/or a hysteresis regulation method and/or a linear regulation method.

The control unit can be configured for switching at least one of the switching units based on a direction and/or strength of a current and/or based on a height of a voltage.

The control unit can for example be configured for switching at least one of the first switching unit, the second switching unit, the third switching unit and the fourth switching unit based on or depending on at least one of the following: a height of the voltage at the energy storage unit, a height of the voltage at the connections, a ratio between these voltage heights, a direction and/or strength of a current across the first connection line between the first connection and the second node, a direction and/or strength of a current across the third connection line between the third node and the second note, a direction and/or strength of a current across the first connection line between the first node and the first ole, a strength of the charging current for the energy storage unit, a strength of the discharge current for the energy storage unit.

According to one embodiment the control unit can be configured for closing the third switching unit during an optional first step. The control unit can also close the second switch during this first step. Closing the second switch can also take place simultaneously, before or after the closing of the third switching unit.

The control unit can further be configured for closing the first switching unit during a second step, in particular if a current flows or is present from the first connection to the second node, or if a charging current flows or is present. The presence of a current can be defined in such a way here that a strength of the current is greater than a lower threshold value, for example 0 A. The control unit can open the third switching unit during an optional third step, in particular immediately after closing the first switching unit. In this way the charging current for the energy storage unit can advantageously flow substantially completely via the first switching unit. Herne, the first switching unit can have a higher current carrying capacity than the third switching unit.

According to a further embodiment, which can be combined with other embodiments of the present disclosure, the control unit can be configured for closing the third switching unit during an optional first step. The control unit can also close the second switching unit during this first step. Closing the second switch can also take place simultaneously, before or after the closing of the third switching unit. The control unit can further be configured for opening the third switching unit during a second step. The control unit can be configured for closing the third switching unit during a third step. The control unit can carry out the second and the third steps repeatedly and alternately. In other words, the control unit can open and close the third switching unit repeatedly and alternately. The control unit can therefore be configured for opening and closing the third switching unit repeatedly and alternately in such a way that a median time value or a maximum value of the current strength of the discharge current and/or a current from the third node to the second node is equal to or smaller than the discharge current threshold value.

The control unit can be configured for opening and closing the third switching unit repeatedly and alternately based on a predefined pre-charging switching frequency and/or based on a predefined pre-charging duty cycle, i.e. to switch it repeatedly and alternately. The control unit can carry out a pulse width modulation method for switching the third switching unit in this way. The control unit can be configured for setting and/or changing the pre-charging switching circuit and/or the pre-charging duty cycle. The control unit can for example be configured for changing, in particular for reducing or increasing, continuously and/or in stages the pre-charging switching frequency and/or the pre-charging duty cycle.

The control unit can be configured for opening the third switching unit during the second step if the current strength of the current from the third node to the second node or the discharge current is greater than a predefined first threshold value, or if it exceeds this threshold value. The control unit can be configured for closing the third switching unit during the third step if the current strength is equal to or smaller than a predefined second step or falls below the same. The second threshold value can be equal to or smaller than the first threshold value here. The control unit can therefore carry out a two-point regulation method or a hysteresis regulation method. The first threshold value can be equal to or greater than the discharge current threshold value here. Accordingly the maximum value or the median time value of the current strength of the discharge current or the current from the third node to the second node can be limited to the discharge current threshold value.

According to yet another embodiment, which can be combined with other embodiments of the present disclosure, the control unit can be configured for closing the first switching unit. The control unit can be configured for carrying out this step if the current strength from the third node to the second node and/or the current strength of the discharge current is equal to or smaller than a predefined third threshold value or falls short of the third threshold value and/or if a difference between the height of the voltage at the energy storage unit and the height of the voltage at the connections is equal to or smaller than a predefined fourth threshold value or falls short of the fourth threshold value. The difference can be the result of a subtraction of the height of the voltage at the connections from the height of the voltage at the energy storage unit. The control unit can be configured for subsequently leaving the first switching unit continuously closed, in particular not to open it anymore. The control unit can be configured for opening the third switching unit after closing the first switching unit, in particular immediately after this. The control unit can be configured for leaving the third switching nit continuously open, in particular not to close it anymore. The fourth threshold value can equal a maximum admissible voltage difference between the voltage at the energy storage unit and the voltage at the connections.

The control unit can be configured for controlling the pre-charging circuit, in particular for increasing or maintaining the voltage at the energy storage unit during a charging process of the energy storage unit or when a charging current flows for charging the energy storage unit and/or for maintaining the current strength of the charging current. The control unit can in particular be configured for switching the fourth switching unit for increasing or maintaining the voltage at the energy storage unit and/or for increasing and maintaining the current strength of the charging current.

According to a further embodiment, which can be combined with other embodiments of the present disclosure, the control unit can be configured for closing the second switching unit during an optional first step. The control unit can also close the first switching unit during this first step. The control unit can be configured for opening the first switching unit during an optional second step. The control unit can be configured for closing the fourth switching unit during a third step. The control unit can be configured for opening the fourth switching unit during a fourth step. The control unit can be configured for opening the second switching unit during an optional fifth step. The control unit preferably opens the control unit if the SOC of the energy storage unit has reached more than 99%, in particular approximately or almost 100%, and/or when the voltage U at the energy storage unit has reached a predefined value. The third switching unit can be opened or closed during the first to fifth steps. The third switching unit is preferably closed at least when the fourth switching unit is open.

According to some embodiments the control unit can open the first switching unit according to the optional second step and the fourth switching unit according to the third and fourth steps and switch it for the first time when the current from the first connection to the second node and/or when the charging current is equal to or smaller than a booster threshold value or falls short of the booster threshold value and/or when the voltage at the connections and/or the voltage at the energy storage unit is greater than a predefined charging voltage threshold value.

The control unit can be configured for alternately and/or repeatedly carrying out the third step and the fourth step. In other words, the control unit can be configured for opening and closing the fourth switching unit repeatedly and alternately. The control unit can in particular be configured for opening and closing the fourth switching unit repeatedly and alternately in such a way that a median time value or a minimum value of the current strength of the charging current and/or a current across the first connection line from the first connection to the second node is equal to or greater than the booster threshold value.

The control unit can be configured for opening and closing the fourth switching unit repeatedly and alternately based on a predefined charging switching frequency and/or based on a predefined charging duty cycle here, i.e. to switch the same repeatedly and alternately. The control unit can therefore carry out a pulse width modulation method for switching the fourth switching unit. The control unit can be configured for setting and/or changing the loading switching frequency and/or the loading duty cycle. The control unit can for example be configured for changing the loading switching frequency and/or the loading duty cycle continuously and/or in stages, in particular for reducing or increasing the same.

The control unit can be configured for closing the fourth switching unit during the third step if the current strength of the current from the first connection to the second node or the current strength of the charging current is smaller than a predefined first charging threshold value or exceeds this threshold value. The control unit can be configured for opening the fourth switching unit during the third step if the current strength is equal to or greater than a predefined second charging threshold value or if it exceeds the same. The second charging threshold value can be equal to or greater than the first charging threshold value here. The control unit can carry out a two-point regulation method or a hysteresis regulation method in this way. The first threshold value can be equal to or greater than the booster threshold value here. Accordingly, the minimum value or the median time value of the current strength of the charging current or the current from the first connection to the second node can be maintained at the booster threshold value.

The charging current can therefore be maintained or increased and/or the voltage at the energy storage unit can be maintained or increased during a charging process of the energy storage unit or whilst a charging current flows. The pre-charging circuit can accordingly be used as an upwards converter (“boost converter”, “booster”). It can therefore be ensured during a charging process of the energy storage unit by means of an external charging device that the energy storage unit is reliably charged up to an SOC of 100%.

An external charging device can therefore be used for charging the energy storage device with negative tolerance with regard to the charging end voltage of the energy storage device and a communication between the energy storage device and the charging device is not required for this. The booster can also be realized simply, as the free-wheeling diode needs to be realized only with the parasitic diode of a fourth switching unit, in particular a power transistor such as a MOSFET, and the control unit is to be configured for switching the fourth switching unit.

According to a further aspect of the present disclosure a pre-charging control method for an energy storage device according to the embodiments of the present disclosure is provided.

The pre-charging control method according to the embodiments comprises an optional step for closing the third switching unit. The second switching unit can also be closed here. The pre-charging control method further comprises a step for closing the first switching unit when a current flows the first connection to the second node or when a charging current flows, and an optional step for opening the third switching unit after closing the first switching unit, in particular immediately after closing the first switching unit.

According to alternative or additional embodiments the pre-charging control method comprises an optional step for closing the third switching unit. The second switching unit can also be closed here. The method further comprises the step for opening the third switching unit and a step for closing the third switching unit.

The step for opening the third switching unit and the step for closing the third switching unit can be carried out repeatedly and/or alternately based on a predefined pre-charging switching frequency and/or based on a predefined pre-charging duty cycle, i.e. the third switching unit can be switched repeatedly and alternately based on the predefined switching frequency and/or based on the predefined duty cycle. A pulse width modulation method can therefore be carried out. The pre-charging switching frequency and/or the pre-charging duty cycle can be changed continuously or in stages here, in particular reduced or increased.

Alternatively the step for opening the third switching unit can be carried out if the current strength of a current from the third node to the second node or the discharge current for the energy storage unit is greater than a predefined threshold value or exceeds this first threshold value and/or the step for closing the third switching unit can be carried out if the current strength is equal to or smaller than a predefined second threshold value or falls short of the second threshold value. The second threshold value can be equal to or smaller than the first threshold value here. A two-point regulation method or a hysteresis regulation method can therefore be carried out. The first threshold value can be equal to or greater than the discharge current threshold value here.

According to a further aspect of the present disclosure a charging control method for an energy storage device according to the embodiments of the present disclosure is provided. The method comprises an optional first step for closing the second switching unit. The first switching unit can also be closed during this step. The method comprises an optional second step for opening the first switching unit. The method comprises a third step for closing the fourth switching unit and a fourth step for opening the fourth switching unit. The method comprises an optional fifth step for opening the second switching unit. The third switching unit can be opened or closed during the method. The third switching unit is preferably closed at least when the fourth switching unit is opened.

The third and fourth steps can in particular be carried out alternately and/or repeatedly. To put it differently, the fourth switching unit can be opened and closed repeatedly and alternately, in particular based in a predefined charging switching frequency and/or based on a predefined charging duty cycle.

A pulse width modulation method can therefore be carried out for switching the fourth switching unit. The switching frequency and/or the duty cycle can be changed continuously or in stages here, in particular reduced or increased.

The third step can also be carried out for closing the fourth switching unit if the current strength of a current from the first connection to the second node or the charging current for the energy storage unit is smaller than a predefined first charging threshold value or falls below this threshold value and/or the fourth opening of the fourth switching unit can be carried out if the current strength is equal to or greater than a predefined second charging threshold value or falls below the second threshold value. The second charging threshold value can be equal to or greater than the first charging threshold value for this. A two-step regulation method or a hysteresis regulation method can therefore be carried out. The first threshold value can be equal to or smaller than the booster threshold value here.

According to the embodiments the second to fourth steps can be carried out if the current from the first connection to the second node and/or the charging current for the energy storage unit is equal to or smaller than the predefined booster threshold value or falls short of the booster threshold value.

According to a further aspect of the present disclosure a pre-charging control method for an energy storage system according to the embodiments of the present disclosure is provided. The pre-charging control method for an energy storage system comprises carrying out the pre-charging control method for at least one, preferably several of the energy storage devices according to the embodiments of the present disclosure. The pre-charging control method can in particular be carried out for all energy storage devices of the energy storage system at the same time.

According to a further aspect of the present disclosure a charging control method for an energy storage system according to the embodiments of the present disclosure is provided. The charging control method for an energy storage system comprises carrying out the charging control method for at least one, preferably several of the energy storage devices according to the embodiments of the present disclosure. The charging control method can in particular be carried out for all energy storage devices of the energy storage system at the same time.

The water vessel can be a ship, a boat or a ferry or comprise the same. The first pole of the energy storage unit can be a plus pole of the energy storage unit and the second pole of the energy storage unit can be a minus pole of the energy storage unit. The energy storage device according to the embodiments of the present disclosure is generally suitable for applications where several energy storage devices are or will be connected with each other in one energy storage system. The energy storage device is for example suitable for electric vehicles, stationary stores, large technical plants etc.

The control unit can be configured for setting and/or changing the discharge current threshold value and/or the charging current threshold value. The discharge current threshold value and/or the charging current threshold value can therefore be variable or adjustable.

Exemplary embodiments will be described with reference to the figures. Identical, similar or identically acting elements are identified with identical reference numbers in the different figures and repeated descriptions of these elements are partly omitted in order to avoid redundancies.

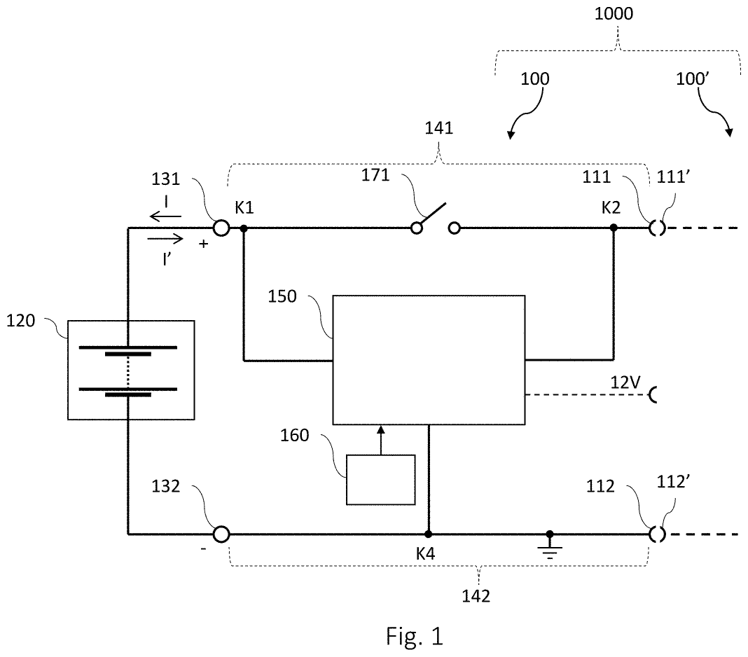

FIG. 1 shows a schematic view of an energy storage device for a water vessel according to the embodiments of the present disclosure.

The energy storage device 100 comprises a first connection 111 and a second connection 112, and an energy storage unit 120 with a first pole 131 and a second pole 132, wherein the first pole 131 is connected with the first connection 111 and the second pole 132 with the second connection 112. More precisely, the first pole 132 is connected with the first connection 111 via a first connection line 141, and the second pole 123 is connected with the second connection 112 via the second connection line 142. The energy storage unit 120 is configured for storing electric energy.

The energy storage device 100 further comprises a first switching unit 171. The first switching unit 171 is arranged in the first connection line 141 between the first node K1 and the second node K2, i.e. it is connected with the first node K1 and the second node K2. The first switching unit 171 is configured for switching a current from the first node K1 to the second node K2. The first switching unit 171 can also be described as a first main switch.

The energy storage device 100 is configured for being connected with at least one further energy storage device 100′ in an energy storage system 1000 through parallel connection for a water vessel (not shown) by means of the first connection 111 and the second connection 112, which is illustrated in FIG. 1 as dotted lines by the first and second connection 111′, 112′ and connection lines of the energy storage device 100′.

According to the embodiments of the present disclosure the energy storage system 1000 comprises two or more energy storage devices 100, 100′ according to the embodiments of the present disclosure, wherein the energy storage devices 100, 100′ are connected with each other by parallel connection by means of the first and second connections 111, 111′, 112, 112′. The energy storage system 1000 is configured for supplying an electric load (not shown), for example an electric drive motor of the water vessel, by means of the electric energy from the energy storage units 120 with electric energy.

If at least two such energy storage devices 100, 100′ are connected in parallel with energy storage units 120 with the same nominal voltage but different charge states (“state of charge”, abbreviated to “SOC”) and therefore different voltage heights are connected with each other in parallel, a compensation of the energy content or the charge states between the energy storage units 100, 100′ through corresponding compensating currents takes place. A current flow from the energy storage unit with a higher charge state, and therefore with a higher voltage to the energy storage unit with a lower charge state, and therefore with a lower voltage, occurs here. The energy storage unit with the higher charge state is therefore discharged by a discharging current and the energy storage unit with the lower charge state is charged by a charging current.

According to the present disclosure the energy storage device 100 comprises a pre-charging circuit 150 and a control unit 160. The control unit 160 is configured for controlling the pre-charging circuit 150 for limiting the strength of a discharge current I′ for the energy storage unit 120 to a predefined discharge current threshold value. The pre-charging circuit 150 therefore has the character of a (constant) current source in this regard. A compensating current between the energy storage devices 100, 100′ connected with each other in parallel is therefore possible, which is mostly independent of the charge state of the respective energy storage units 120. The pre-charging circuit 150 can therefore be operated as a down converter (“buck converter”).

The energy storage device 100 can further be configured for not limiting the strength of a charging current I for the energy storage unit 120 or for limiting the strength of the charging current I to a charging current threshold value that is greater than the discharge current threshold value. As the charging current I is not, or is limited only to a threshold value that is greater than the threshold value for the discharge current I′, the pre-charging circuit 150 can be used for a so-called asymmetric pre-charging of energy storage devices 100, 100′ in an energy storage system 1000.

The discharge current I′ here describes a current from the energy storage unit 120 across the first pole 131, i.e. a current from the second pole 132 across the energy storage unit 120 to the first pole 131, and the charging current I describes a current across the first pole 131 to the energy storage unit 120, i.e. a current from the first pole 131 across the energy storage unit 120 to the second pole 132.

According to the embodiment shown in FIG. 1 the energy storage unit 120 comprises one or more battery modules schematically indicated in FIG. 1, which are connected in a series and/or in parallel. The battery module or modules each comprise one or more battery cells (not shown) connected in series and/or in parallel. The energy storage device 100 can therefore be described as a battery and the energy storage system as a battery system or battery bank. The battery cell or the battery cells can be lithium based, in particular lithium ion based.

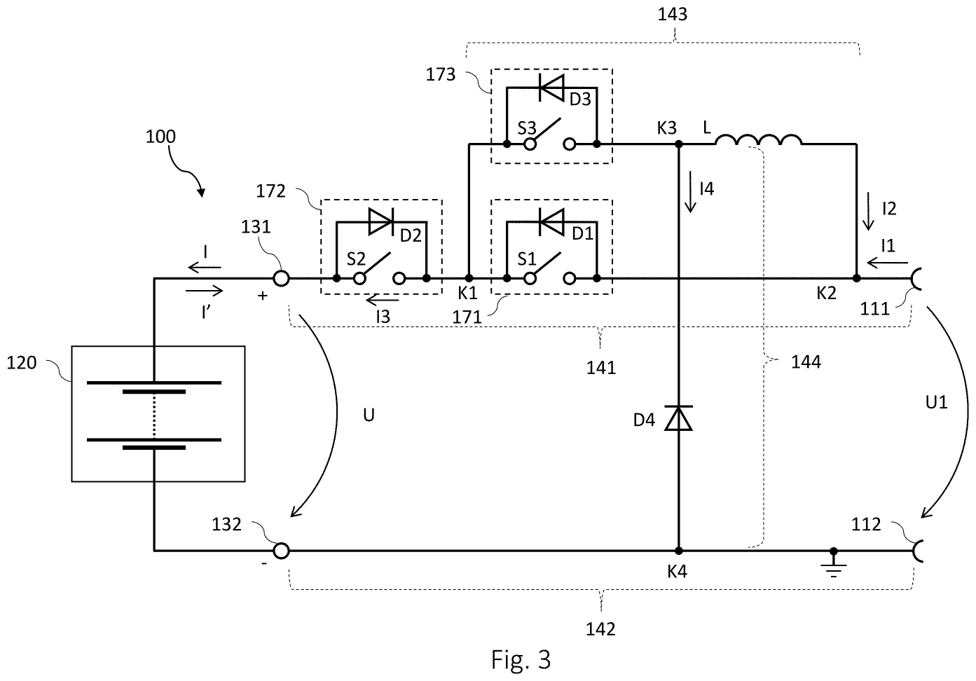

The battery module or modules are connected with the first and second poles 131, 132 of the energy storage unit 120 for providing or receiving electric energy across the same and providing a voltage U (see FIG. 3) between the poles 131, 132. The poles 131, 132 are of opposite polarity, wherein the first pole 131 of the plus pole and the second pole 132 the minus pole. In other words, the first pole 131 can form the cathode of the energy storage unit 120 and the second pole 132 can form the anode of the energy storage unit 120 in a resting condition or during a discharge process of the energy storage unit 120. The minus pole 132 can be connected with a mass of the energy storage device 100 and/or the energy storage system 100. The voltage U can be positive. The voltage U can also be described as the voltage of the energy storage unit 120.

The energy storage unit 120 can be formed in such a way that a value for a maximum possible charging current for the energy storage unit 120 is equal to or greater than (N−1) times the discharge current threshold value. The charging current threshold value can also be equal to or greater than (N−1) times the discharge current threshold value. Here, N represents the number of energy storage devices 100 connected in parallel in the energy storage system 100. With N identical energy storage devices 100 in parallel connection in the energy storage system it is therefore possible that a single energy storage unit 120 can receive currents that can supply the other N−1 energy storage units 120 during the asymmetric pre-charging as respective discharge currents I′ as a charging current I, without the charging current I having to be interrupted for this energy storage unit 120 for safety reasons.

The first connection line 141 has a first node K1, which is connected with the first pole 131, and a second node K2, which is connected with the first connection 111. The second connection line 142 has a fourth node K4, which is connected with the second pole 132 and the second connection 112. The first connection and the second connection 111, 112 can be arranged on a housing (not shown) of the energy storage device 100, lying freely externally, and can therefore be described as external connections.

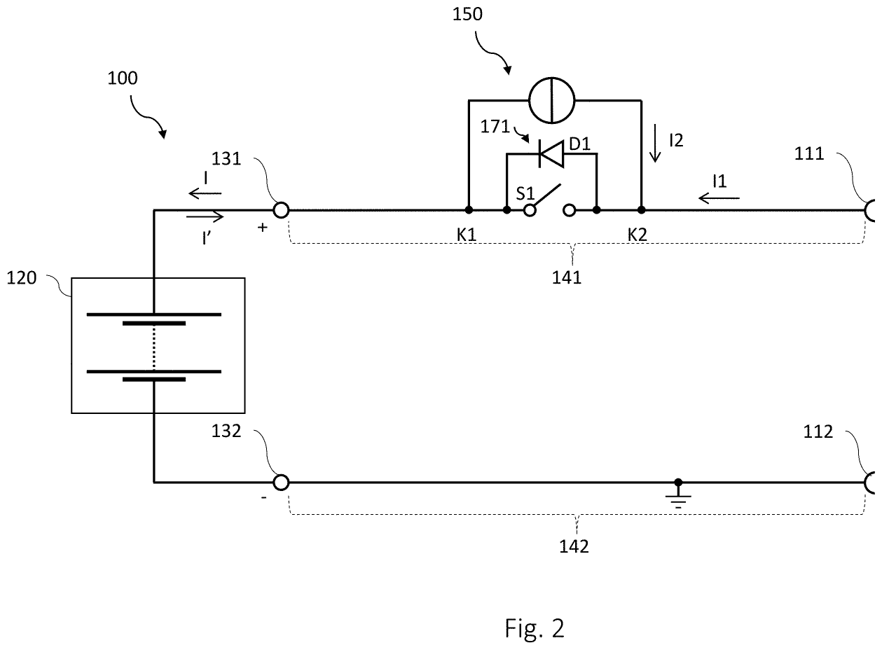

FIG. 2 shows a schematic view of an energy storage device for a water vessel according to the embodiments of the present disclosure. The current source character and the voltage source character of the pre-charging circuit are illustrated with the aid of FIG. 2.

In FIG. 2, the first switching unit 171 comprises a first switch S1 and a first diode D1. The first switch S1 is connected with the first node K1 and the second node K2 and is configured for switching a current between the first node K1 and the second node K2 across the same. The first diode D1 is connected in parallel with the first switch S1, i.e. the first diode D1 is also connected with the first node K1 and the second node K2. The first diode D1 is arranged for a current across the same from the first node K1 to the second node K2 in reverse direction and is arranged for a current across the same from the second node K2 to the first node K1 in forward direction. Accordingly the anode of the first diode D1 is connected with the second node K2 and the cathode of the first diode D1 is connected with the first node K1.

As shown in FIG. 2, the first switching unit 171 is configured for switching a current from the first node K1 to the second node K2 across the first switching unit 171, in particular for interrupting the same, but cannot be configured for interrupting a current from the second node K2 to the first node K1 across the first switching unit 171 due to the diode D1.

The first switching unit 171 can for example be realized as a power switch, in particular as a power transistor, for example as a MOSFET, which is lockable only in one direction (forward direction). The power switch cannot be lockable for a current in the other direction, the direction opposite to this direction (reverse direction). The power switch can also be described as reverse non-lockable.

In other words, the power switch can be lockable for a current from the first node K1 to the second node K2 (forward direction) and therefore switch to this current, and not lockable for a current from the second node K2 to the first node K1 (reverse direction) and can therefore not interrupt this current. In this case the diode D1 is advantageously formed by the parasitic diode of the power transistor or the MOSFET.

Therefore, a current I1 can substantially unlimited from the first connection 111 to the second node K2 and from the second node K2 across the first switching unit 171, and possibly across the pre-charging circuit 150 to the first node K1. From there the current flows on to the first pole 131 and to the energy storage unit 120 as charging current I for charging the energy storage unit 120. This charging current I of the energy storage unit 120 is therefore not limited by the pre-charging circuit 50.

On the other hand a discharge current I′ for discharging the energy storage unit 120 flows from the energy storage unit across a first pole 131 to the first node K1 and from there across the pre-charging circuit 150 as current I2 to the second node K2 and to the first connection 111. The pre-charging circuit 150 can limit the current I2, and therefore also the discharge current I′. The pre-charging circuit 150 acts as a current source in this regard. The discharge current I′ of the energy storage unit 120 can be limited by the pre-charging circuit 150 to a predefined discharge current limit value here. According to the embodiments the pre-charging circuit 150 can be formed as a regulated or cycled current source.

The pre-charging circuit 150 therefore enables a current limitation for a discharge current I′ of the energy storage unit 120 and/or no, or a substantially higher current limitation for a charging current I of the energy storage unit 120.

FIG. 3 shows a schematic view of an energy storage device for a water vessel according to the embodiments of the present disclosure. The energy storage device shown in FIG. 3 equals the energy storage device described with reference to FIG. 1 and shows further details of the same. The control unit 160 is not shown in FIG. 3.

The pre-charging circuit 150 comprises a third connection line 143 between the first node K1 and the second node K2 here, with a third node K3 and an inductance L between the third node K3 and the second node K2. The pre-charging circuit 150 further comprises a fourth connection line 144 between the third node K3 and the fourth node K4, and a free-wheeling diode D4, which is arranged in the fourth connection line 144 and is arranged for a current I4 from the third node K3 to the fourth node K4 in reverse direction, and which is arranged for a current from the fourth node K4 to the third node K3 in forward direction. The third connection line 143 therefore comprises a first end, which is connected or can be connected with the first node K1, and a second end, which is connected or can be connected with the second node K2. The third node K3 is therefore arranged between the first end and the second end of the third connection line 143 and the inductance L is arranged between the third node K and the second end of the third connection line 143. The fourth connection line 144 therefore comprises a first end, which is connected with the third node K3, and a second end, which is connected or can be connected with the fourth node K4. The free-wheeling diode D4 is therefore arranged in the fourth connection line 144 between the first end and the second end of the fourth connection line 144 and is arranged for a current from the second end of the fourth connection line 144 to the third node K3 or to the first end of the fourth connection line 144 in forward direction, and is arranged for a current from the third node K3 or from the first end of the fourth connection line 144 to the second end of the fourth connection line 144 in reverse direction.

The pre-charging circuit 150 further comprises a third switching unit 173. The third switching unit 173 is arranged in the third connection line 143 between the first node K1 or the first end of the third connection line 143 and the third node K3, i.e. it is connected with the first node K1 and the third node K3. The third switching unit 173 is configured for switching a current from the first node K1 or from the first end of the third connection line 143 to the third node K3. The first switching unit 171 is therefore connected in parallel with the third connection line 173 with the third switching unit 173 and the inductance L. The inductance L can be realized with a coil or similar.

The energy storage device 100 further comprises a second switching unit 172. The second switching unit 172 can also be described as a second main switch. The second switching unit 172 is arranged in the first connection line 141 between the first node K1 and the first pole 131, i.e. it is connected with the first node K1 and the first pole 131. The second switching unit 172 is configured for switching a current from the first node K1 to the second pole 131.

The arrangement of the second switching unit 172 is not limited to the arrangement of FIG. 2. The second switching unit 172 can for example be arranged in the second connection line 142 between the second pole 132 and the fourth node K4 and is configured for switching a current from the second pole 132 to the fourth node K4.

The control unit 160, which is not shown in FIG. 3, is configured for controlling the first switching unit 171 and the third switching unit 173, and can in particular be configured for switching the first switching unit 171 and the third switching unit 173 to limit the strength of the discharge current I′ for the energy storage unit 120 across the first pole 131 and further to the first node K1 to a predefined discharge current threshold value. The control unit 160 is further configured for switching the second switching unit 172.

The second switching unit 172 and the third switching unit 173 are constructed analogue to the first switching unit 171.

The second switching unit 172 here comprises a second switch S2 and a second diode D2 here. The second switch S2 is connected with the first node K1 and the first pole 131 and is configured for switching a current between the first node K1 and the first pole 131. The second diode D2 is connected in parallel with the second switch S2, i.e. the second diode D2 is also connected with the first node K1 and the first pole 131. The second diode D2 is arranged for a current across the same from the first node K1 to the first pole 131 in reverse direction and is arranged for a current across the same from the first pole 131 to the first node K1 in forward direction. By this realization, the second switching unit 172 is configured for switching a current I3 from the first node K1 to the first pole 131.

The third switching unit 173 here comprises a third switch S3 and a third diode D3. The third switch S3 is connected with a first node K1 and the third node K3 and is configured for switching a current between the first node K1 and the third node K3. The third diode D3 is connected in parallel with the third switch S3, i.e. the third diode D3 is also connected with the first node K1 and the third node K3. The third diode D3 is arranged for a current across the same from the first node K1 to the third node K3 in reverse direction and is arranged for a current across the same from the third node K3 to the first node K1 in forward direction. By this realization, the third switching unit 173 is configured for switching a current from the first node K1 to the third node K3.

Like the first switching unit 171 the second switching unit 172 and the third switching unit 173 can be formed as power switches, in particular as power transistors, preferably as MOSFETs. Correspondingly the second diode D2 and the third diode D3 can also preferably be formed by the parasitic diode of the respective power switch. The power switch for the second switching unit 172 can be lockable for a current from the first node K1 to the first pole 131 (forward direction) here, and therefore switch this current, and the power switch can be non-lockable for a current from the first pole 131 to the first node K1 (reverse direction) and can therefore not interrupt this current. The power switch for the third switching unit 173 can also be lockable for a current from the first node K1 to the third node K3 (forward direction) and therefore switch this current, and the power switch can be non-lockable for a current from the third node K3 to the first node K1 (reverse direction) and can therefore not interrupt this current.

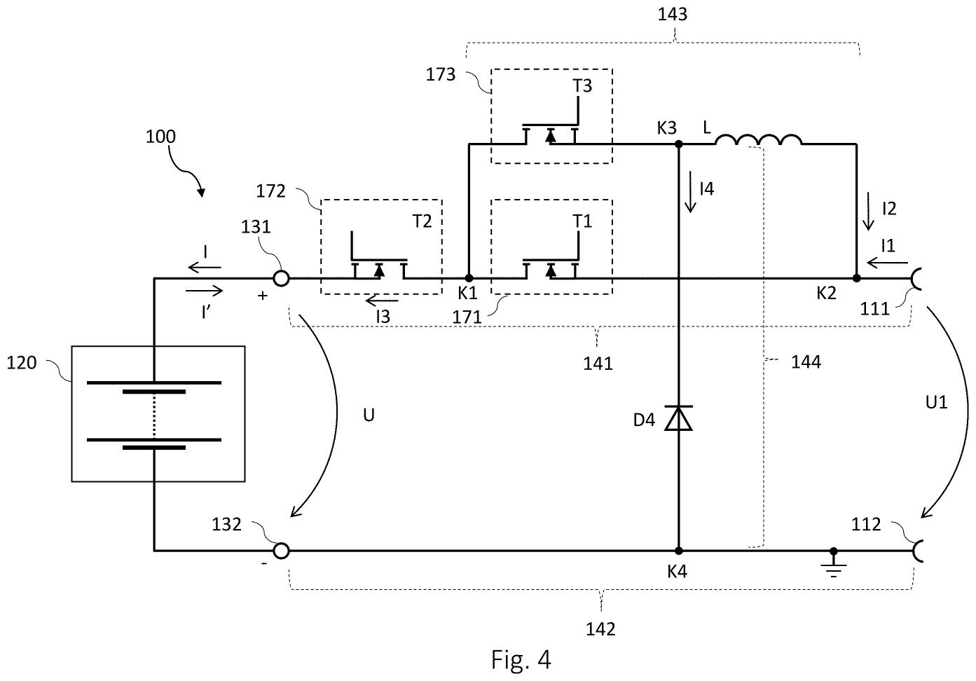

The case that the first to third switching units 171, 172, 173 are formed as power switches, in particular as MOSFETs, is illustrated in FIG. 4.

Opening the second switching unit 172 can interrupt the charging current I and switch it off if necessary. The control unit 160 can then switch or control the charging current I from the first node K1 to the first pole 131 and to the energy storage unit 120 by means of the second switching unit 172.

The control unit 160 can for example switch the second switching unit 172 in such a way, in particular through repeated and alternating opening and closing of the second switching unit 172, that a maximum value of the current strength of charging current I or a median time value of the current strength is equal to or smaller than the predefined charging current threshold value. The charging current I can therefore be limited to the predefined charging current threshold value.

The discharge current I′ can also be interrupted through opening the first switching unit 171 and the third switching unit 173.

The control unit 160 can therefore switch or control the discharge current I′ from the energy storage unit 120 across the first pole 131 to the first node K1 by means of the first switching unit 171 and the third switching unit 173. As described in the following, the discharge current I′ can be limited to a predefined discharge current threshold value through switching the first switching unit 171 and/or through switching the third switching unit 173.

The energy storage device 100 can further comprise measuring devices for currents and voltages not shown here. The measuring devices can be configured for transmitting the respective measured currents or voltages to the control unit 160. The control unit 160 can use the measured currents and voltages for carrying out the control method described below.

For example, a measuring device for measuring a current I1 from the first connection 111 to the second node K2, a measuring device for measuring a current I2 from the third node K3 to the second node K2, a measuring device for measuring a current I3 from the first node K1 to the first pole 131, a measuring device for measuring a current I4 from the third node K3 to the fourth node K4, a measuring device for measuring the charging current I and/or the discharge current I′, a measuring device for measuring the voltage U of the energy storage device 120 and a measuring device for measuring the voltage U1 to the connections can be provided. Measuring a current can comprise determining whether a current in the corresponding direction exists, in particular whether a current strength of the same is greater than a predefined lower threshold value, for example 0 A. Measuring the current can also comprise measuring a current strength. The measuring and transmitting can be carried out repeatedly and/or continuously.

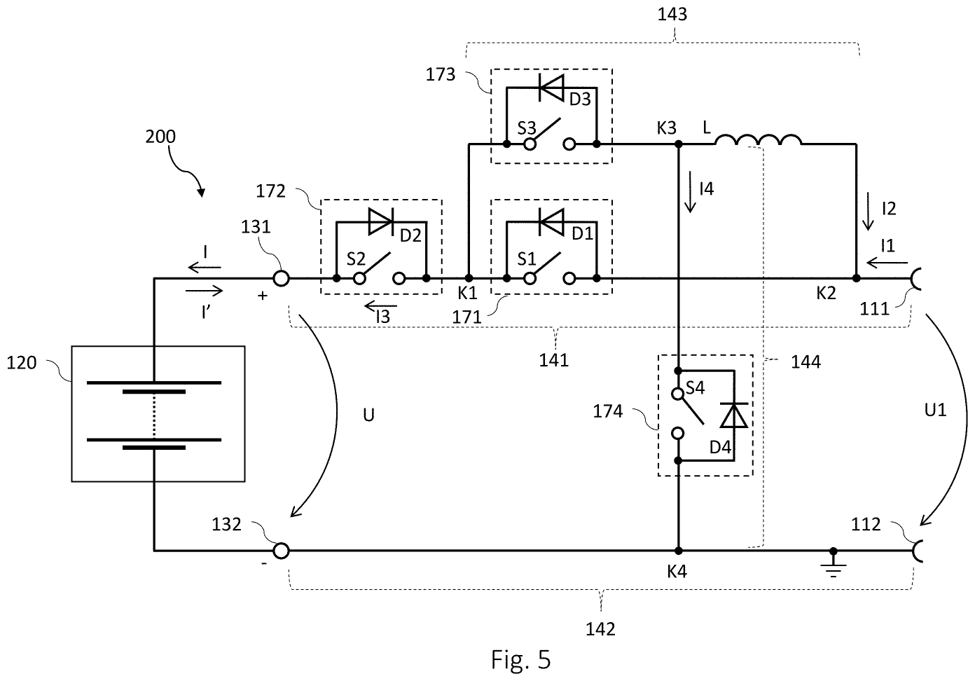

FIG. 5 shows a schematic view of an energy storage device for a water vessel according to second embodiments of the present disclosure. The energy storage device 200 shown in FIG. 5 relates to the energy storage device 100 shown with reference to FIG. 3, with the differences described as follows.

The energy storage device 200 comprises a fourth switching unit 174 here, which is arranged in the fourth connection line 144 between the fourth node K4 and the third node K3. This means that the fourth switching unit 174 is connected with the fourth node K4 and the third node K3. The fourth switching unit 174 is arranged in the fourth connection line 144 between the first end and the second end of the fourth connection line 144 and is configured for switching a current from the third node K3 to the second end of the fourth connection line 144. The fourth switching unit 174 is configured for switching a current from the third node K3 to the fourth node K4. The control unit 160 is further configured for switching the fourth switching unit 174.

According to the embodiment shown in FIG. 5 the fourth switching unit 174 comprises a fourth switch S4 and the free-wheeling diode D4. The fourth switch S4 is connected with the third node K3 and the fourth node K4 and is configured for switching a current across the same between the third node K3 and the fourth node K4. The free-wheeling diode D4 is connected in parallel with the fourth switch S4, i.e. the free-wheeling diode D4 is also connected with the third node K3 and the fourth node K4. The free-wheeling diode D4 is arranged for a current across the same from the third node K3 to the fourth node K4 in reverse direction and is arranged for a current across the same from the fourth node K4 to the third node K3 in forward direction. By this realization, the fourth switching unit 174 is configured for switching the current I4 from the third node K3 to the fourth node K4.

Like the other switching units the fourth switching unit 174 can be formed as a power switch, in particular as a power transistor, preferably as a MOSFET. The free-wheeling diode D4 can be formed by the parasitic diode of the power switch here. The power switch can therefore be lockable for the current I4 from the third node K3 to the fourth node K4 (forward direction) and can therefore switch this current, and the power switch can be non-lockable for a current from the fourth node K4 to the third node K3 (reverse direction) and can therefore not interrupt this current.

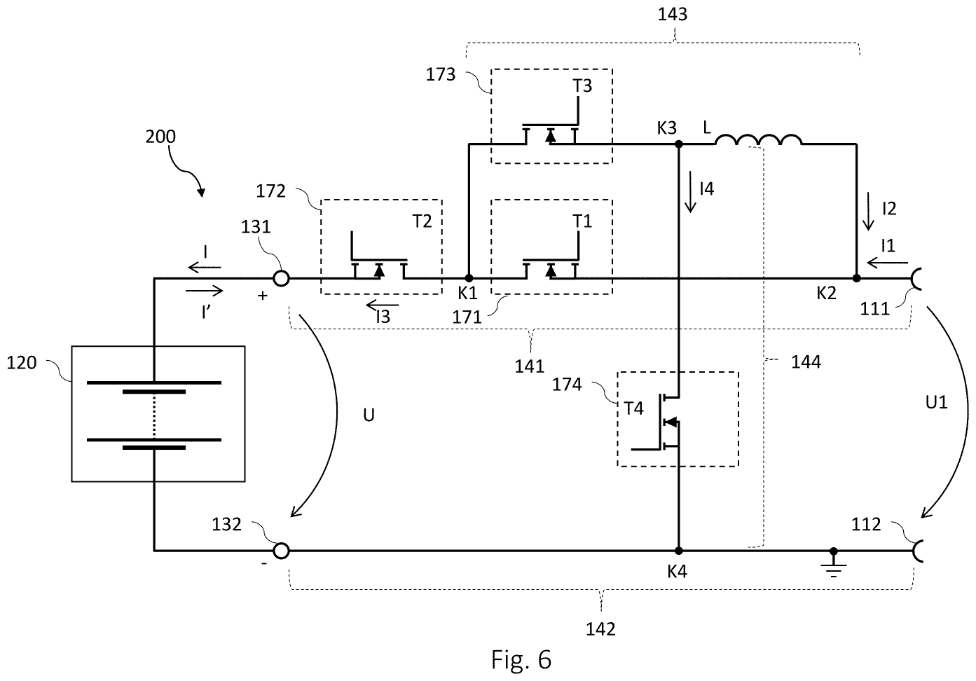

The case that the first to fourth switching units 171, 172, 173 and 174 are each formed as a power switch, in particular a MOSFET, is illustrated in FIG. 6.

The control unit 160 is configured for switching the first to fourth switching units 171, 172, 173, 174 for carrying out control methods for the energy storage device according to embodiments of the present disclosure.

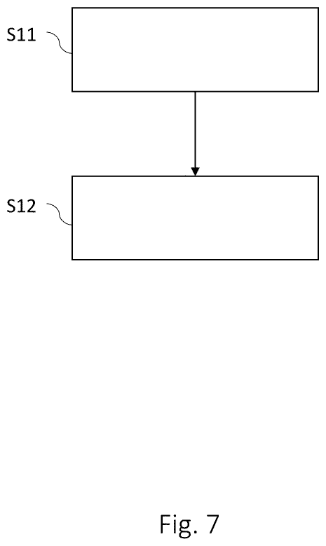

FIG. 7 shows a pre-charging control method according to embodiments of the present disclosure.

The pre-charging control method can be carried out for the energy storage devices shown with reference to FIG. 1 to FIG. 6. The pre-charging control method can in particular be carried out for several, preferably all energy storage devices of an energy storage system connected in parallel according to embodiments of the present disclosure at the same time. With reference to the embodiments of the energy storage device 200 shown in FIG. 5 and FIG. 6 the fourth switching unit 174 should be opened here. The pre-charging control method is preferably carried out when switching on the energy storage system, which is for example formed as a battery bank.

The control unit 160 closes the third switching unit 173 and the second switching unit 172 during a first step S11 here. The control unit 160 can initially open the first control unit 171 or keep it open.

A discharge current I′ as well as a charging current I is enabled for the energy storage unit 120 in this way. Depending on the charge state of the energy storage unit 120 relative to the charge state of the energy storage unit 120 of the other energy storage devices in the energy storage system, a discharge current I′ or a charging current I actually occurs for a respective energy storage unit 120.

Hereby, a discharge current I′ flows for an energy storage unit 120 with a higher charge state compared to the other energy storage units 120, and therefore a higher voltage U from the energy storage unit 120 across the first pole 131 and further across the second switching unit 172, the first node K1, the closed third switching unit 173, the third node K3 and the second node K2 to the first connection 111. Substantially, I2 is equal to I′ here. This discharge current I′ can serve for charging the other energy storage units 120 with a lower charge state.

A current I1 also flows from the first connection 111 to node K2 for an energy storage unit 120 with a lower charge state compared to the other energy storage units 120, and therefore voltage U. The current divides here according to the impedances of the connection lines or current paths between K2 and K1 across the third switching unit 173 or across the first switching unit 171. The current further flows from K1 to the first pole 131 and further as charging current I for the energy storage unit 120. Accordingly, I1 is substantially equal to I. For the case of just two energy storage devices 120 connected in parallel the charging current I of one energy storage unit 120 is also equal to the discharge current I′ of the other energy storage unit 120.

The control unit 160 then carries out pre-charging control methods according to the embodiments described in the following according to a step S12.

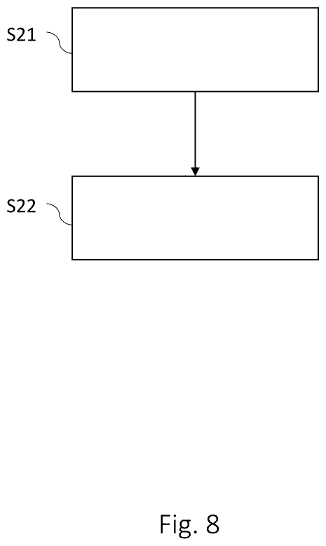

FIG. 8 shows a pre-charging control method according to a first embodiment of the present disclosure.

The pre-charging control method shown here can be carried out by the control unit during step S12 of FIG. 7. Here, the control unit 160 can determine after step S11 of FIG. 7 whether a current I1 flows from the first connection 111 to the second node K2, i.e. whether a current from the first connection 111 to the second node K2 exists. In other words, the control unit 160 determines whether the current strength of current I1 is greater than a predefined lower threshold value, for example 0 A. Alternatively the control unit 160 can determine whether a charging current I exists or whether a current with exists in an opposite direction to current I2. This is in particular the case when the energy storage unit 120 has a lower charge state, and therefore a lower voltage U in relation to the other energy storage units 120 in the energy storage system. In this case the energy storage unit 120 will be charged.

If it is determined that the current I1 or the charging current I exists, the control unit 160 will closes the first switching unit 171 during step S21. If the first switching unit 171 and the third switching unit 173 are formed as a MOSFET, the current I1 coming from node K2 will commutate mostly across the first switching unit 171, i.e. on the first connection line 141 between the second node K2 and the first node K1. This is because of the lower impedance of the MOSFET channel of the switched-on switching unit 171 in the first connection line 141 between the second node K2 and the first node K1 compared to that of the third connection line 143.

In a further optional step S22 the control unit 160 can open the third switching unit 173 immediately after closing the first switching unit 171. The energy stored in inductance L can dissipate across the third diode D3, which is for example formed by a MOSFET. The energy storage unit 120 can be charged with a charging current I with a relatively large current strength or with an unlimited charging current I with the pre-charging control method described here.

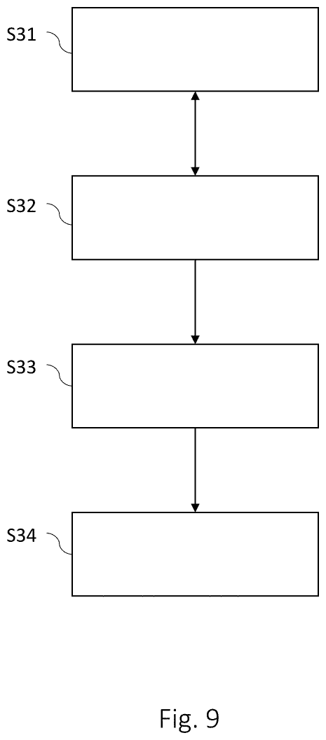

FIG. 9 shows a pre-charging control method according to a second embodiment of the present disclosure. The pre-charging control method shown here can be carried out by the control unit 160 during step S12 of FIG. 7.

The control unit 160 here opens the third switching unit 173 during step S31. The control unit 160 closes the switching unit 173 during a subsequent step S32.

According to the embodiments the control unit 160 can first determine after step S11 of FIG. 7 whether a current I2 flows from the third node K3 to the second node K2, i.e. whether a current I2 from the third node K3 to the second node K2 exists. In other words, the control unit 160 determines whether the current strength of current I2 is equal to or greater than a predefined lower threshold value, for example 0 A. Alternatively the control unit 160 can determined whether the discharge current I′ exists or whether a current with an opposite direction to that of current I1 exists. This is in particular the case when energy storage unit 120 has a higher charge state in relation to the other energy storage units 120 in the energy storage system, and therefore has a voltage U. In this case the energy storage unit 120 is discharged. The control unit 160 can carry out the steps S31 and S32 here if it is determined that a current I2 flows from the third node K3 to the second node K2.

When the third switching unit 173 is opened a current flow across the third switching unit 173 is interrupted. The discharge current I′ will be interrupted or 0 A. The current I2 until the time of opening the switching unit 173 can commutate across the fourth connection line 144 and the free-wheeling diode D4, whereupon the current I2 decreases. When the control unit 160 closes the switching unit 173 again the current strength of the current I2, and therefore also the current strength of the discharge current I′, can increase again.

The alternate opening and closing of the third switching unit 173 also makes it possible to control the current strength of the discharge current I′. A maximum value or a median time value of the current strength can for example be controlled, and in particular limited to the predefined discharge current threshold value.

According to the embodiments the control unit 160 is configured for repeatedly and alternately opening and closing the third switching unit 173, namely for repeatedly and alternatively switching the same, which is illustrated in FIG. 9 with a double arrow between steps S31 and S32. The control unit 160 can limit the current strength of discharge current I′ to the discharge current threshold value in this way. The control unit 160 can in particular limit a median time value or a maximum value of the current strength of discharge current I′ to the discharge current threshold value in this way.

The control unit can in particular carry out a pulse width modulation method for the alternate and repeated switching of the third switching unit 173. Here, an opening period of the third switching unit 173 defines a time period between opening and closing, namely the time period during which the third switching unit 173 is opened. A closing period of the third switching unit 173 defines a time period between closing and opening, namely the time period during which the third switching unit 173 is closed. A reciprocal value of the sum of the opening period and the closing period can be defined as the switching frequency. A ratio between the closing period and the sum of the opening period and the closing period can be defined as the cycle degree or duty cycle of the pulse width modulation method. A large duty cycle can correspond to a large pulse width and vice versa. A pulse width can correspond to the closing period. With regard to the pre-charging control method described with reference to the pre-charging control method described in FIG. 9 the switching frequency and the duty cycle are also described as pre-charging switching frequency or pre-charging duty cycle.

The switching frequency, the closing period, the opening period and/or the cycle relationship can be predefined. These parameters can in particular be predefined or set by the control unit 160 and/or changed by the control unit 160. The control unit 160 can be configured for changing these parameters in stages and/or continuously. The control unit 160 can for example set the duty cycle in such a way that the median time value or maximum value of the current strength limits the current strength of the discharge current I′ and/or the current I2 to the discharge current threshold value.

The control unit 160 can for example set the duty cycle or the opening period in such a way that the average current strength of the current I2 or the discharge current I′ is initially approximately 20 A, or is limited to this, is then approximately 15 A, or is limited to this, and is subsequently approximately 10 A, or is limited to this. The duty cycle and/or the closing period is therefore reduced in stages here.

The switching frequency can for example be 100 kHz. The control unit 160 can therefore implement a linear limitation regulator here.

According to further embodiments the control unit 160 opens the third switching unit 173 during step S31 if the current strength of the discharge current I′ of current I2 from the third node K3 to the second node K2 or the current with an opposite direction to that of current I1 is greater than a predefined first threshold value, or exceeds this threshold value. The current I2 through L then commutates across the fourth connection line 144 and the free-wheeling diode D4, whereupon the current I2 decreases.

The control unit 160 then closes the third switching unit 173 when the current strength is equal to or smaller than a predefined second control value or falls short of this threshold value. The current strength of current I2 to the discharge current I′ can increase again this way. The second threshold value can therefore be equal to or smaller than the first threshold value. The control unit 160 can therefore carry out a two-point regulation method or a hysteresis regulation method. The first threshold value can be equal to or greater than the discharge current threshold value here. The maximum value or the median time value of the discharge current I′ or the current I2 can accordingly be limited to the discharge current threshold value.

According to further embodiments the control unit 160 closes the first switching unit 171 during a step S33 following step S32 if the current strength of the current I2 from the third node K3 to the second node K2 and/or the discharge current I′ is equal to or smaller than a predefined third threshold value, or falls short of this threshold value and/or if a difference between voltage U at the energy storage unit 120 and voltage U1 at the connections 111, 112 is equal to or smaller than a predefined fourth threshold value, or falls short of the same. The third threshold value can be smaller than the first and/or second threshold value.

In a following step S35 the control unit 160 can open the third switching unit 173 immediately after closing the first switching unit 141. The control unit 160 can be configured for subsequently leaving the first switching unit 171 continuously closed, i.e. to no longer switch the same. The control unit 160 can leave the third switching unit 173 continuously open, i.e. no longer switch the same.

The fourth threshold value can equal a maximum admissible voltage difference between voltage U at the energy storage unit 120 and voltage U1 at connections 111, 112. According to the embodiments the load can therefore be taken off the first switching unit 171 as the main switch. As long as the third threshold value is not reached or is fallen short of and/or as long as the fourth threshold value is not reached or is fallen short of the discharge current I′ for energy storage unit 120 is routed via the pre-charging circuit 150, more precisely via the third connection line 143 between the first node K1 and the third node K3, where it can be switched by the third switching unit 173. The strength of the discharge current I′ can therefore be limited to a predefined discharge current threshold value.

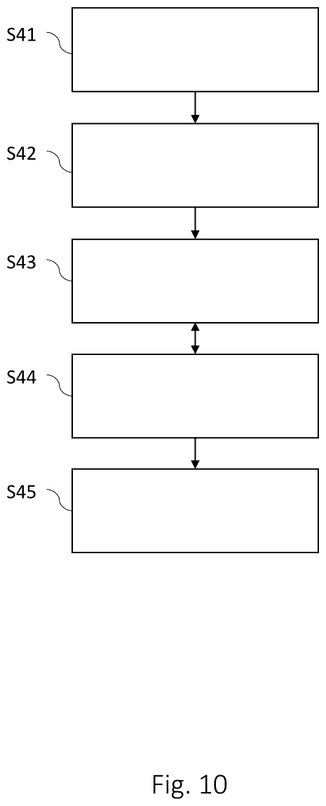

FIG. 10 shows a charging control method according to an embodiment of the present disclosure. The control method can be carried out for the energy storage device shown with reference to FIG. 5 and FIG. 6. The charging control method can in particular be carried out for several or all energy storage devices of an energy storage system connected in parallel according to embodiments of the present disclosure at the same time. The charging control method can also be described as a boost method or boost process.

The charging control method shown here can be carried out as part of or during a charging process for loading the energy storage unit 120. The charging process can be carried out by an external charging device, which is connected with connections 111, 112. The charging process can be a CCCV charging process.

The control unit 160 initially closes the second switching unit 172 during an optional first step S41 here. The control unit 160 can also close the first switching unit 171 during this step. Closing the first switching unit 171 can take place before, simultaneous to or after closing the second switching unit 172. A current I1 provided by the external charging device can therefore flow from the first connection 111 t the second node K2, and from there to the first pole 131. A charging current I for the energy storage unit 120 results from this, i.e. charging current I substantially corresponds to current I1. The control unit 160 can also open the fourth switching unit 174. A current I4 across the fourth connection line 144 is therefore initially prevented.

The control unit 160 can open the third switching unit 173 here. If the first and third switching units 171, 173 are formed as MOSFETs, as discussed with reference to FIG. 8, the current I2 coming from the node K2 commutates mostly across the first switching unit 171, i.e. on the first connection line 141 between the second node K2 and the first node K1 because of the lower impedance of the MOSFET channel of the switched-on MOSFET 171. The third switching unit 173 can however also be closed.

During an optional second step S42 the control unit 160 opens the first switching unit 171. A current flow across the first connection line 141 from the first node K1 to the second node K2 is prevented during the subsequent steps in this way.

The control unit 160 closes the fourth switching unit 174 during a third step S43. In this way, a current I4 from node K3 to the fourth node K4 is enabled. A current flow from the first connection 111 across the second node K2, the inductance L and the third node K3, and further across the fourth connection line 144 to the fourth node K4 results. Energy is therefore stored in inductance L in this phase.

The control unit 160 then opens the fourth switching unit 174 during the fourth step S44. The current from node K3 across the fourth connection line 144 to the fourth node therefore changes to the third connection line 143 between the third node K3 and the first node K1. A current I3 flows further to the first pole 131 from there, and continues as a charging current I to the energy storage unit 120. The energy stored by inductance L is therefore supplied to the energy storage unit 120. At the same time voltage U at the energy storage unit 120 is increased or maintained and the current strength of the charging current I for charging the energy storage unit 120 is increased or maintained.

If the switching unit 173 according to the embodiments include the third switch S3 and the third diode D3, and if the switching unit 173 is in particular formed as a power switch, for example a MOSFET, the third diode D3 will take over the current from node K3 after opening the fourth switching unit 174. The control unit 160 can be configured for closing the third switching unit 173 after opening the fourth switching unit 174 to minimize losses.

The control unit 160 can be configured for opening the second switching unit 172 during an optional fifth step S45. The charging current I for the energy storage unit 120 will be interrupted in this way and the charging process can be terminated. The control unit 160 preferably opens the second switching unit 172 if the SOC of the energy storage unit 120 has reached more than 99%, approximately or substantially 100% and/or if the voltage U at the energy storage unit 120 has reached a predefined value. If the charging current I for the energy storage unit 120 is interrupted this can be determined with the external charging device and the external charging device can terminate the charging process.

According to the embodiments the control unit 160 can open the first switching unit 171 according to step S42 and switch the fourth switching unit 174 according to steps S43 and S44 for the first time if the current I1 from the first connection 111 to the second node K2 and/or if the charging current I is equal to or smaller than a booster threshold value or falls short of the booster threshold value and/or if voltage U1 at the connections 111, 112 and/or voltage U at the energy storage unit 120 is greater than a predefined charging voltage threshold value.

Voltage U at the energy storage device 120 can be maintained or increased during the charging process by the external charging device through switching the fourth switching unit 174. The current strength of the charging current I for the energy charging unit 120 can also be maintained or increased in this way. The pre-charging circuit 150 can therefore be operated as an upwards converter or boost converter.

It can be ensured with the external charging device during a charging process of the energy storage unit 120 that the energy storage unit 120 is charged up to an SOC of 100%. The boost converter can also be realised simply, as the free-wheeling diode D4 is to be realised only with the parasitic diode of the fourth control unit 174, in particular a power transistor such as a MOSFET, and the control unit 160 is to be configured for switching the fourth switching unit 174.

The energy storage device 200 can therefore carry out a kind of final precision charging of the energy storage unit 120 with the pre-charging circuit 150 as and when required. The desired SOC of the energy storage unit 120 of 100% can therefore be reached reliably irrespective of the installation type. An external charging device for charging the energy storage device 200 with negative tolerance can therefore be used. “Negative tolerance” means here that the external charging device already transfers to the constant current phase prior to the constant voltage phase if the voltage U1 at connections 111, 112 or a voltage U at the energy storage unit 120 reaches a value that lies below the actual charging end voltage of the energy voltage unit 120. This value can also be described as “internal charging end voltage of the external charging device”. A charging end voltage of the energy storage unit 120 can for example lie at 30 V, the internal charging end voltage of the external charging device can lie at 29 V, and the charging voltage threshold value, where the pre-charging circuit 150 begins switching the fourth switching unit 174, can lie at 28 V.

A communication of the energy storage device 200 with the charging device is not necessary. Any external charging device model and/or producer that complies with the requirements of the charging end voltage of the energy storage unit 120 can be used. The final charging of the energy storage unit 120 can take place with higher power compared with charging with just an external charging device. A switching-in of battery banks in parallel configurations is also simplified in this way.

According to the embodiments the control unit 160 is in particular configured for carrying out the steps S43 and S44 alternately and/or repeatedly, which is illustrated in FIG. 10 by a double arrow between steps S43 and S44. The control unit 160 can be configured for repeatedly and alternately close and open the fourth switching unit 174 according to steps S43 and S44, i.e. to switch the same repeatedly and alternately. The control unit 160 can be configured for repeating and alternately opening and closing the fourth switching unit 174 in such a way that a median time value or a minimum value of the current strength of charging current I and/or current I1 across the first connection line 141 from the first connection 111 and to the second node K2 is equal to or greater than a booster threshold value.

The control unit 160 can in particular be configured for repeatedly and alternately switching the fourth switching unit 174 based on a predefined switching frequency and/or based on a predefined duty cycle, also described as cycled or periodic switching. The control unit 160 can carry out a pulse width modulation method for switching the fourth switching unit 174 in this way. An opening period of the fourth switching unit 174 determines a time period between opening and closing here, i.e. the time period during which the fourth switching unit 174 is open. A closing period of the fourth switching unit 174 determines a time period between closing and opening, i.e. the time period during which the fourth switching nit 174 is closed. A reciprocal value of the sum of the opening period and the closing period can be defined as the switching frequency of the fourth switching unit 174. A ratio between the closing period and the sum of the opening period and the closing period can be defined as a cycle degree or duty cycle of the pulse width modulation method for the fourth switching unit 174. A large duty cycle can equal a large pulse width and vice versa here. A pulse width can correspond to the closing period of the fourth switching unit 174. The switching frequency can for example equal approximately 100 kHz. The switching frequency, the closing period, the opening period and/or the duty cycle can be predefined. These parameters can in particular be predefined or set by the control unit 160 and/or changed by the control unit 160. The control unit 160 can be configured for changing these parameters in stages and/or continuously. With regard to the charging control method described in FIG. 10 the switching frequency and the duty cycle are also described as charging switching frequency or charging duty cycle.

The control unit 160 can also carry out a two-point regulation method or a hysteresis regulation method. The control unit 160 can be configured for closing the fourth switching unit 174 during the third step S43 if the current strength of the current I1 from the first connection 111 to the second node K2 or the charging current I is smaller than a predefined first charging threshold value or exceeds this threshold value. The control unit 160 can be configured for opening the fourth switching unit 174 during the fourth step S44 if the current strength is equal to or greater than a predefined second charging threshold value or exceeds the same. The second charging threshold value can be equal to or greater than the first charging threshold value here. The first threshold value can be equal to or greater than a booster threshold value here. Accordingly, the minimum value or the median time value of the current strength of the charging current I or the current I1 can be maintained as the booster threshold value.

The control unit 160 can be configured for reducing the booster threshold value, the closing period and/or the duty cycle or the first charging threshold value and/or the second charging threshold value whilst carrying out the charging control method or during the charging process. The effect of the voltage increase at the energy storage unit 120 can be reduced gradually or the minimum value or the median time value of the current strength of the charging current I can be reduced gradually in this way. The booster effect of the charging control method or the pre-charging circuit 150 can therefore be reduced with an increasing SOC of the energy storage unit 120.

The value of the maximum current strength that can by maximally carried and switched by the third switching unit 173 can be described as the current carrying capacity of the third switching unit 173. The current carrying capacity of the third switching unit 173 can correspond to approximately one tenth of the current carrying capacity of the first switching unit 171 and/or the second switching unit 172. According to the embodiments the current carrying capacity of the third switching unit 173 can equal the booster threshold value and/or the discharge threshold value.

According to the embodiments the control units of the respective energy storage devices can communicate with each other in an energy storage system with several energy storage devices according to the embodiments of the present disclosure. If the pre-charging control method according to the embodiments of the present disclosure is currently being carried out for at least one of the energy storage devices it can be ensured with this that the charging control method for the other energy saving devices is not carried out. It can in particular be prevented in this way that one or more energy saving devices are discharged, whilst the boost process for the other energy storage devices is carried out at the same time.

The pre-charging circuit according to the embodiments of the present disclosure can therefore be used as a direct current converter (“DC/DC converter”), i.e. as a down converter (“buck converter”) as well as an upwards converter (“boost converter”) and enables a current limitation for discharge currents of the energy storage unit or currents from the energy storage device (“forward”), in particular for a pre-charging. A balancing between energy storage devices connected in parallel can be carried out for as long as necessary. The pre-charging circuit can for example limit a discharge current to 6 A and/or an output capacity of 250 W, in particular for loads without their own limit switch (so-called “dumb loads”). The pre-charging circuit also enables the detection of short circuits. It is also possible that solar systems can provide charging current for charging the energy storage unit or currents into the energy storage device (“backward”). The pre-charging circuit further enables provision of a 12V output (“forward”) (see FIG. 1), for example for charging the 12V on-board systems of a water vessel. The 12V output can also be used as an input for currents (“backward”), for example for charging with solar systems or for emergency applications. As a direct current converter the pre-charging circuit further enables a voltage stabilization for sudden internal switch-off conditions, for example when an emergency stop signal occurs.

Where applicable all individual features illustrated in the exemplary embodiments can be combined and/or replaced with each other without leaving the scope of the disclosure. From the foregoing description, it will be apparent that variations and modifications may be made to the embodiments of the present disclosure to adopt it to various usages and conditions. Such embodiments are also within the scope of the following claims.

1-22. (canceled)

23. An energy storage device for a water vessel, the energy storage device comprising:
a first connection and a second connection;
an energy storage unit with a first pole and a second pole;
a first connection line between the first pole and the first connection, wherein the first connection line has a first node (K1), which is connected with the first pole, and a second node (K2), which is connected with the first connection;
a second connection line between the second pole and the second connection, wherein the second connection line has a fourth node (K4), which is connected with the second pole and the second connection;
a third connection line between the first node (K1) and the second node (K2), with a third node (K3) and an inductance (L) between the third node (K3) and the second node (K2), a fourth connection line between the third node (K3) and the fourth node (K4), and a free-wheeling diode (D4), which is arranged in the fourth connection line, which is arranged for a current from the fourth node (K4) to the third node (K3) in forward direction;
a first switching unit in the first connection line between the first node (K1) and the second node (K2) for switching a current from the first node (K1) to the second node (K2) and a third switching unit in the third connection line between the first node (K1) and the third node (K3) for switching a current from a first node (K1) to the third node (K3); and
a control unit, which is configured for controlling at least one of the first switching unit or the third switching unit for limiting a strength of a discharge current (I′) for the energy storage unit to a predefined discharge current threshold value.

24. The energy storage device according to claim 23, wherein at least one of:
the first switching unit comprises a first switch (S1) and a first diode (D1) connected with the first switch (S1) in parallel, which is arranged for a current from the first node (K1) to the second node (K2) in reverse direction; or
the third switching unit comprises a third switch (S3) and a third diode (D3) connected with the third switch (S3) in parallel, which is arranged for a current from the first node (K1) to the third node (K3) in reverse direction.

25. The energy storage device according to claim 23, wherein at least one of the first switching unit or the third switching unit are formed as power switches, wherein the corresponding diode (D1, D3) is formed by a parasitic diode of the power switches.

26. The energy storage device according to claim 23, wherein the control unit is configured for switching at least one of the first switching unit or the third switching unit based on at least one of a pulse width modulation method, a two-point regulation method, a hysteresis regulation method, or a linear regulation method.

27. The energy storage device according to claim 23, wherein the control unit is formed as a limiting regulator, or the control unit comprises the limiting regulator.

28. The energy storage device according to claim 23, wherein the control unit is configured for switching at least one of the first switching unit or the third switching unit based on at least one of the following: a direction of a current across the first connection line between the first connection and the second node (K2), a strength of the current across the first connection line between the first connection and the second node (K2), a direction of a current across the third connection line between the third node (K3) and the second node (K2), a strength of the current across the third connection line between the third node (K3) and the second node (K2), a direction of a current across the first connection line between the first node (K1) and the first pole, a strength of the current across the first connection line between the first node (K1) and the first pole, a strength of a charging current (I) for the energy storage unit, a strength of the discharge current (I′) for the energy storage unit, a height of a voltage of the energy storage unit, a height of a voltage at the connections, or a relationship between the height of the voltage of the energy storage unit and the height of the voltage at the connections.

29. The energy storage device according to claim 23, wherein the control unit is configured for:
closing the first switching unit when a current (I1) flows from the first connection to the second node (K2) or when a charging current (I) flows; and
opening the third switching unit after closing the first switching unit.

30. The energy storage device according to claim 23, wherein the control unit is configured for:
opening the third switching unit when a current strength of at least one of the discharge current (I′) or a current (I2) from the third node (K3) to the second node (K2) is equal to or greater than a predefined first threshold value or exceeds the first threshold value; and
closing the third switching unit when the current strength is equal to or smaller than a predefined second threshold value or falls short of the predefined second threshold value, wherein the second threshold value is equal to or smaller than the first threshold value.

31. The energy storage device according to claim 23, wherein the control unit is configured for alternately opening and closing the switching unit in such a way that a median time value or a maximum value of a current strength of at least one of the discharge current (I′) or a current (I2) from the third node (K3) to the second node (K2) is equal to or smaller than the discharge current threshold value.

32. The energy storage device according to claim 23, wherein the control unit is configured for closing the first switching unit and for opening the third switching unit after closing the first switching unit when at least one of:
at least one of a current strength of a current (I2) from the third node (K3) to the second node (K2) or the discharge current (I′) for the energy storage unit is equal to or smaller than a predefined third threshold value or falls short of the predefined third threshold value; or
a difference between a voltage (U1) at the connections and a voltage (U) at the energy storage unit is equal to or smaller than a predefined fourth threshold value or falls short of the predefined fourth threshold value.

33. The energy storage device according to claim 23, further comprising a second switching unit, wherein:
the second switching unit is arranged in the first connection line between the first node (K1) and the first pole and is configured for switching a current from the first node (K1) to the first pole; or
the second switching unit is arranged in the second connection line between the second pole and the fourth node (K4) and is configured for switching a current from the second pole to the fourth node (K4).

34. The energy storage device according to claim 33, wherein:
the second switching unit comprises a second switch (S2) and a second diode (D2) connected with the second switch (S2) in parallel, which is arranged for a current from the first node (K1) to the first pole in reverse direction; or
the second switching unit comprises the second switch (S2) and the second diode (D2) connected with the second switch in parallel, which is arranged for a current from the second pole to the fourth node (K4) in reverse direction.

35. The energy storage device according to claim 23, further comprising a fourth switching unit, which comprises the free-wheeling diode (D4), wherein the fourth switching unit is arranged in the fourth connection line between the third node (K3) and the fourth node (K4) and is configured for switching a current from the third node (K3) to the fourth node (K4).

36. The energy storage device according to claim 35, wherein the fourth switching unit is formed as a power switch, and wherein the free-wheeling diode (D4) is formed by a parasitic diode of the power switch.

37. The energy storage device according to claim 35, wherein the control unit is configured for alternately closing and opening the fourth switching unit in such a way that at least one of: a median time value or a minimum value of a current strength of a charging current (I); or a current (I1) across the first connection line between the first connection and the second node (K2) is equal to or greater than a predefined booster threshold value.

38. The energy storage device according to claim 37, wherein:
the energy storage unit is or comprises at least one battery cell; or
the energy storage unit is or comprises at least one battery module with at least one battery cell.

39. The energy storage device according to claim 38, wherein the at least one battery cell is a lithium based battery cell.

40. An energy storage system for a water vessel, comprising two or more energy storage devices according to claim 38, which are connected with each other in parallel by means of a first and second connections.

41. A pre-charging control method for an energy storage device according to claim 23, comprising at least one of the steps:
closing the first switching unit when a current (I1) flows from the first connection to the second node (K2) or when a charging current (I) flows, after closing the first switching unit, opening the third switching unit;
opening the third switching unit when a current strength of a current (I2) from the third node (K3) to the second node (K2) or the discharge current (I′) is greater than a predefined first threshold value or exceeds the first threshold value, and closing the third switching unit when the current strength is equal to or smaller than a predefined second threshold value or falls short of the second threshold value, wherein the second threshold value is equal to or smaller than the first threshold value;
alternating opening of the third switching unit and closing of the third switching unit based on at least one of a predefined pre-charging switching frequency or a predefined pre-charging duty cycle, wherein at least one of the pre-charging switching frequency or the pre-charging duty cycle are changed continuously or in stages; or
closing the first switching unit when at least one of:
the current strength of the current (I2) from the third node (K3) to the second node (K2) or the current strength of the discharge current (I′) is equal to or smaller than a predefined third threshold value or falls short of the third threshold value; or
a difference between a height of a voltage (U) at the energy storage unit and a height of the voltage at the connections is equal to or smaller than a predefined fourth threshold value or falls short of the fourth threshold value.

42. A charging control method for an energy storage device according to claim 35, comprising the steps:
alternating closing of the fourth switching unit and opening of the fourth switching unit,
wherein the fourth switching unit is alternately opened and closed based on at least one of a predefined charging switching frequency or a predefined charging duty cycle.

43. A pre-charging control method for the energy storage system according to claim 40, comprising the steps:
closing a second switching unit of each of the energy storage devices, wherein:
the second switching unit is arranged in the first connection line between the first node (K1) and the first pole and is configured for switching a current from the first node (K1) to the first pole; or
the second switching unit is arranged in the second connection line between the second pole and the fourth node (K4) and is configured for switching a current from the second pole to the fourth node (K4); and
carrying out the pre-charging control method according to claim 41 for all of the energy storage devices of the energy storage system.

44. A charging control method for the energy storage system according to claim 40, comprising the steps:
carrying out the charging control method according to claim 42 for the energy storage device of the energy storage system.

45. An energy storage device for a water vessel, the energy storage device comprising:
a first connection and a second connection;
an energy storage unit that is connected with the first connection and the second connection, wherein the energy storage device is configured for being connected in parallel with at least one further energy storage device by means of the first connection and the second connection; and
a control unit and a pre-charging circuit, wherein the control unit is configured for controlling the pre-charging circuit for limiting a strength of a discharge current (I′) for the energy storage unit to a predefined discharge current threshold value.

46. A pre-charging circuit for an energy storage device for a water vessel, wherein:
the energy storage device comprises:
a first connection and a second connection;
an energy storage unit with a first pole and a second pole;
a first connection line between the first pole and the first connection, wherein the first connection line has a first node (K1), which is connected with the first pole, and a second node (K2), which is connected with the first connection;
a second connection line between the second pole and the second connection, wherein the second connection line has a fourth node (K4), which is connected with the second pole and the second connection; and
a first switching unit in the first connection line between the first node (K1) and the second node (K2) for switching a current from the first node (K1) to the second node (K2); and
the pre-charging circuit comprises:
a third connection line comprising:
a first end, which can be connected with the first node (K1);
a second end, which can be connected with the second node (K2);
a third node (K3) between the first end and the second end; and
an inductance (L) between the third node (K3) and the second end;
a fourth connection line with a first end, which is connected with the third node (K3), and a second end, which can be connected with a fourth node (K4);
a free-wheeling diode (D4) in the fourth connection line between the first end and the second end of the fourth connection line, which is arranged for a current from the third node (K3) to the second end of the fourth connection line in reverse direction; and
a third switching unit in the third connection line between the first end of the third connection line and the third node (K3) for switching a current from the first end of the third connection line to the third node (K3).

47. The pre-charging circuit according to claim 46, further comprising a fourth switching unit, which comprises the free-wheeling diode (D4), wherein the fourth switching unit is arranged in the fourth connection line between the first end and the second end of the fourth connection line and is configured for switching a current from the third node (K3) to the second end of the fourth connection line.
